(19) United States
(12) Patent Application Publication
(10) Pub. No.: US 2010/0205105 A1
(43) Pub. Date: Aug. 12, 2010

(54) System and Method for Providing Electronic Passenger and Luggage Handling Services over a Distributed Network

(76) Inventors: Steven C. Robertson, Kent, WA (US); Michael Henry Schneider, Gig Harbor, WA (US)

Correspondence Address: PATRICK M. DWYER PC, 14419 Greenwood Avenue N #322, SEATTLE, WA, 98133, US

(21) Appl. No.: 12/686,980

(22) Filed: Jan. 13, 2010

Related U.S. Application Data
(63) Continuation of application No. 10/057,048, filed on Jan. 23, 2002, now abandoned.

(51) Int. Cl. G06Q 30/00

(52) U.S. Cl. 705/334

(57) ABSTRACT

An online Skycap Service provides for the use of managing luggage handling services across multiple service partners and destinations. It further provides for the tracking of luggage via an embedded RF chip. Users and Service Providers initially register with the mySkyCap Service and are provided additional functionality. For users, the system provides for families to schedule all the individual travel segments separately and have the entire itinerary transaction acted upon as a single financial transaction. It also allows for a hassle-free method for the transportation of luggage between travel destinations. For Service Providers, the ability to track luggage and associate it with travelers provides for increased security. A distinct advantage of this system is that it allows for the pickup and drop off of luggage at the convenience of the traveler and allows them to travel without worrying about their luggage. Another advantage is that it saves time from having to deal with luggage check-in and out at each destination—this is especially advantageous for large families with lots of children.

### CROSS-REFERENCE TO RELATED APPLICATIONS

This application is a Continuation of Ser. No. 10/057,048 filed Jan. 23, 2002.

### BACKGROUND

1. Field of Invention

The present invention relates to a system and method whereby passengers may check in their luggage ahead of time and have it be delivered to their final destination in a secure and reliable manner. This invention further provides the ability to track the item from its original departure location to its final destination.

2. Description of Prior Art

Traditionally, passengers would check-in their luggage upon arrival at the airport, bus station, railroad, or other form of transportation. At the airport this may be either at the curb-side with the Airport Skycap service or with the airline when checking in at the front desk. More often than not, dealing with luggage slowed down the check-in process and thus required airlines to hire additional customer service representatives to handle the workflow of trying to get passengers to their planes on time. In addition, after recent terrorist events, the need for security is higher now than ever.

Customer representatives are responsible for handling ticketing, baggage check-in, and printing of boarding passes. They also perform security checks and ask passengers questions about their luggage. The entire process is time consuming and inconvenient. What is needed is a method whereby passengers can have their luggage picked up at their homes or offices and delivered to their final destinations securely with no hassle. This is especially valuable for large families with small children and it reduces the confusion and chance of losing items or having them stolen. The luggage could alternatively travel separately from the passenger as the passenger only cares that it reaches the final destination when the passenger needs it. Thus the passenger may have options such as quickest method, cheapest method, and standard method of traveling with passenger.

### SUMMARY

The present invention provides a system and method in which individuals manage the pickup, tracking, and delivery of their luggage on a trip, whether for business or pleasure. They can arrange for pickup at their homes, offices, hotels, or any desired location and have it delivered to their final destination, whether that is a cruise line, hotel, or some other desired location. Likewise, they can also arrange for the return of their luggage at the same time or at a later time. In addition, the present invention allows travelers to put out individual travel segments for bids from multiple service providers.

The present invention provides a system and method in which Service/Product Providers host their own content as directly-accessible sites (referred to herein as “SP sites”) on a distributed network such as the Internet, while relying on a centralized mySkyCap site to handle secure and private transactions with their customers.

In a preferred embodiment the SP sites are in the form of Web sites on the Internet, and the passengers will require a single authentication before being passed over to the mySkyCap site for luggage handling. In addition, the service partner would maintain the passenger's mySkyCap ID in their customer profile.

An alternative embodiment is for the mySkyCap site to host product and service pages of merchants. In this embodiment, the mySkyCap site sends the orders to the merchant through whatever means is available once the purchase is confirmed. Orders and reservations in these circumstances may be sent by faxes or phone if an electronic transmission path is not provided. The advantage of this method is it allows merchants that are not currently on-line to participate in the process. Some examples of these types of merchants may be smaller tour companies.

Likewise, an alternative embodiment would allow for passengers that weren't previously authenticated to authenticate upon arrival at the mySkyCap site and to sign-up if they didn't previously have an account.

One significant benefit of above-described approach is that the service partner can reduce the number of customer service personnel due to the more streamlined process of not having to deal with as much luggage. Only those passengers that choose not to use mySkyCap would have to be serviced. If this was combined with online check-in and boarding pass ticketing, the need for the traditional ticketing counter could be seriously reduced.

The system and method of invention are advantageously suited for use over an unsecured public network such as the Internet. In general, however, the system and method can be used on any type of distributed network over which Merchants provide online services to users. This may include both trusted and un-trusted networks and public, private, or hybrid public-private networks.

In accordance with the invention, passengers (customers) that wish to make use of the mySkyCap must initially register with online site, and are in-turn provided with any client software components needed to make use of the mySkyCap Services. Upon registration, users provide account information to the mySkyCap site such as payment information (e.g. credit card number), name, address, and phone number. This information is maintained in a traveler database at a mySkyCap central site, and is not exposed to the Merchants, franchisees, or any un-authorized person. Each user additionally selects a password, and is assigned a unique ID, which is used for authentication purposes.

Another significant benefit of the above-described approach is that the Merchants need not be concerned with credit card fraud as their financial dealings are with the mySkyCap Site rather than the shoppers. The cost to a Merchant for this system would be minimal in that server-side code would be provided. In addition, industry standards would be used where applicable.

A further advantage is that the luggage can travel independently of the traveler, which provides for additional options beyond having it travel with the passenger on the plane.

The various embodiments and method will become more apparent on consideration of the drawings and ensuing description.

### OBJECTS AND ADVANTAGES

Accordingly, the objects and advantages of the present invention are:
(a) to provide a system and method which allows for the scheduling of luggage handling services across multiple service partners.
(b) to provide a system and method whereby luggage may be picked up ahead of time, but still only loaded on an airline, train, or bus if the associated traveler is checked in.
(c) to provide a system and method whereby luggage can be tracked as to its location.
(d) to provide a system and method which allows for the aggregation of travel segment reservations.
(e) to provide a system and method which allows for the registration of luggage.
(f) to provide a system and method which allows individual travel segments to be put out for bid.
(g) to provide a system and method that allows for remote check-in of luggage.
(h) to provide a system and method whereby luggage will be delivered to final destination independently of the corresponding traveler.
(i) to provide a system and method whereby the traveler does not have to wait at the airport or transportation facility for the luggage prior to being transported to their destination.
(j) to provide a system and method which allows for a family to store and maintain all their travel information such as frequent flyer numbers in a central location
(k) to provide a system for the centralized tracking of luggage.
(l) to provide a system for increased security by associating luggage with respective individuals and not allowing luggage to be loaded without the respective individual also boarding the airline or other transportation mode.
(m) to provide a system for increased security whereby luggage can be removed from an airline or other transportation mode if the associated individual also exits the mode of transportation.
(n) to provide a system for allowing hand-held devices and wireless devices to access a traveler's viewing information and receive updates while in-route.
(o) to provide a system for obtaining luggage status and location information while in-route.

Further objects and advantages of this invention will become apparent from a consideration of the drawings and ensuing description.

### BRIEF DESCRIPTION OF THE DRAWINGS

These and other features and advantages of the invention will now be described with reference to the drawings of certain preferred embodiments, which are intended to illustrate and not to limit the invention, and in which:

FIG. 1 illustrates the general architecture of a system, which operates in accordance with the present invention.

FIG. 2 is a flow chart representation of the steps taken by a family to register with mySkyCap.

FIG. 3 is a flow chart representation of the steps taken by a family to add a family member to their profile.

FIG. 4 is a flow chart representation of the steps taken by a family to add luggage to their profile.

FIG. 5 is a flow chart representation of the steps taken by a family to modify the family profile.

FIG. 6 is a flow chart representation of the steps taken by a family to modify a family member profile.

FIG. 7 is a flow chart representation of the steps taken by a family to modify a luggage profile.

FIG. 8 is a flow chart representation of the steps taken by a family member to create an itinerary.

FIG. 9 is a flow chart representation of the steps taken by a family member to modify an itinerary.

FIG. 10 is a flow chart representation of the steps taken by a family member to add or modify a travel segment to an itinerary.

FIG. 11 is a flow chart representation continuation steps from FIG. 10 showing branching based on travel segment status.

FIG. 12 is a flow chart representation of the steps taken by the system for a new travel segment.

FIG. 13 is a flow chart representation of the steps taken by the system if the travel segment is awaiting a response from a service partner.

FIG. 14 is a flow chart representation of the steps taken by the system if the travel segment is awaiting bids by a service partner or a bid selection from the traveler.

FIG. 15 is a flow chart representation of the steps taken by the system if the travel segment if the reservation has been accepted by the service partner.

FIG. 16 is a flow chart representation of the steps taken by the system if the traveler has confirmed the accepted reservation from the service partner.

FIG. 17 is a flow chart representation of the steps taken by the system upon receiving a reservation request response from a travel partner.

FIG. 18 is a flow chart representation of the steps taken by the system upon receiving a travel reservation bid.

FIG. 19 is a flow chart representation of the steps taken by the system for checking travel reservations that have been put on hold for too long.

FIG. 20 is a flow chart representation of the steps taken by a family member to confirm an itinerary.

FIG. 21 is a flow chart representation of the steps taken by the system once a family member confirms an itinerary.

FIG. 22 is the general architecture the field facilities, where travelers check their luggage.

FIG. 23 is the hardware architecture of the remote unit and mobile unit apparatuses.

FIG. 24 is a flow chart representation of the steps taken by the traveler while performing pre-check-in.

FIG. 25 is a flow chart representation of the steps when the traveler checks their luggage with a service partner.

FIG. 26 is a flow chart representation of the continuation steps from FIG. 25.

FIG. 27 is a flow chart representation of the steps taken by the system for each piece of luggage.

FIG. 28 is a flow chart representation of the steps when the system detects problems after a scan of a luggage.

FIG. 29 is a flow chart representation of the steps taken by the system for each luggage that does not have any scan problems.

FIG. 30 is a flow chart representation of the steps taken by a service partner when performing a transfer of ownership of the luggage and passengers.

FIG. 31 is a flow chart representation of the steps taken by a service partner for transfer a single piece of luggage.

FIG. 32 is a flow chart representation of the steps taken by a service partner for handing off to another service partner.

FIG. 33 is a flow chart representation of the steps taken by mySkyCap Customer Service to resolve a potential theft.

FIG. 34 is a flow chart representation of the steps taken by mySkyCap Customer Service for updating travel segment information or travelers picking up their luggage.

FIG. 35 is a flow chart representation of the steps taken by mySkyCap Customer Service when updating travel segment information.

FIG. 36 is a flow chart representation of the steps taken by mySkyCap Customer Service when delivering luggage to a traveler.

FIG. 37 is a flow chart representation of the steps taken by a service partner when updating travel segment information in their own system and sending a notification to mySkyCap.

FIG. 38 is the general architecture of the airport baggage handling facilities.

FIG. 39 is a flow chart representation of the steps taken by the system upon luggage arriving at the RF Baggage Holding area in a Transportation Facility such as an airport.

FIG. 40 is a flow chart representation of the continuation steps from FIG. 39 once the luggage is delivered to the CTX X-Ray Device.

FIG. 41 is a flow chart representation of the steps taken by the system if the luggage does not have an airline baggage tag.

FIG. 42 is a flow chart representation of the steps taken by the system for checking if baggage has been waiting in the holding area for too long without the passenger checking in.

FIG. 43 illustrates the process whereby luggage is shipped via Air Freighters.

FIG. 44 illustrates the process whereby luggage shipped by Air Freighters reaches its destination and is transferred to a Delivery Partner.

FIG. 45 illustrates the communications, which takes place between the mySkyCap site, the service partners, and the travelers.

### REFERENCE NUMERALS IN DRAWINGS

10 Traveler Computer
12 Client Application
20 Telephone
30 Hand-held Device
32 Hand-held Client Application
40 Internet (Or Other Public Network)
50 SP Site
52 SP Server Application
54 mySkyCap Client Application
70 mySkyCap Site
72 mySkyCap Server Application
74 Traveler Database
76 Luggage Database
80 Itinerary Database
82 Partner Database
90 Open Travel Alliance Database
100 Visitor Locates mySkyCap Site
102 Visitor Makes a Request to Register a Family
104 mySkyCap Site Displays Family Registration Form
106 User Provides Family Profile Information and Desired Authentication Information
108 mySkyCap Site Assigns Unique Identifier for the Registered Family
110 mySkyCap Site Saves Family Registration in Traveler Database
112 mySkyCap Site Sends an E-mail Confirmation of Registration to the Visitor
114 Add Family Member?
116 Add Luggage?
120 Family Profile Owner Chooses to Add a Family Member
122 mySkyCap Displays Family Member Profile Form
124 Family Profile Owner Enters Basic Family Member Information
126 Family Profile Owner Indicates Family Member Role and Permissions
128 Set Traveler Status to ‘Idle’
130 Add Frequent Flyer Information?
132 Family Profile Owner Enters Frequent Flyer Information for Family Member
134 Save?
136 Save Family Member Profile
140 Family Profile Owner Chooses to Register Luggage
142 mySkyCap Displays Luggage Profile Form
144 Family Profile Owner Enters Basic Luggage Information
146 Save?
148 Save Luggage Profile
150 Set Luggage Status to ‘Idle’
152 Set Luggage Custody to Owner
154 Register More Luggage?
160 Family Member Accesses Their Secured Family Profile
162 Family Member Chooses to Modify Family Profile
164 Authorized?
166 Display Unauthorized Warning
168 mySkyCap Site Displays Pre-populated Family Profile Form
170 User Enters Information and Submits Form
172 Form Valid?
174 Update Family Profile in Passenger Database
176 Display Family Profile Modification Confirmation
180 Family Member Chooses to Modify a Family Member Profile
182 Authorized?
184 Display Unauthorized Warning
186 mySkyCap Site Displays Pre-populated Family Member Profile Form
188 User Enters Information and Submits Form
190 Form Valid?
192 Update Family Member Profile in Passenger Database
194 Display Family Member Profile Modification Confirmation
200 Family Member Chooses to Modify a Luggage Profile
202 Authorized?
204 Display Unauthorized Warning
206 mySkyCap Site Displays Pre-populated Luggage Profile Form
208 User Enters Information and Submits Form
210 Form Valid?
212 Update Luggage Profile in Luggage Database
214 Display Luggage Profile Modification Confirmation
220 Family Member Chooses to Create an Itinerary
222 Set Itinerary Status to ‘New’
224 Authorized?
226 Display Unauthorized Warning
228 mySkyCap Displays Itinerary Page
230 Add Travel Segment?
232 Create New Travel Segment
234 Set Travel Segment Status to ‘New’
240 Family Member Chooses to Modify an Itinerary
242 Authorized?
244 Display Unauthorized Warning
246 More than 1 Itinerary Available?
248 Display List of Itineraries
250 Family Member Chooses an Itinerary
252 mySkyCap Displays the Itinerary
254 Modify Travel Segment?
256 Cancel Travel Segment?
258 Set Travel Segment Status to ‘Canceled’
260 Send Cancellation Notice to Service Partner if Confirmed
270 mySkyCap Displays Travel Segment Form
272 Family Member Chooses Origination Point Type & Location
274 Additional Origination Information Required?
276 Family Member Enters Additional Origination Information
278 Family Member Chooses Destination Point Type & Location
280 Additional Destination Information Required?
282 Family Member Enters Additional Destination Information
284 Family Member Enters Date & Time
286 Family Member Enters Optional Comments
288 Family Member Confirms Changes
289 System Saves Changes
   290 Travel Segment Status=‘New’ or Status=‘Reservation Rejected’ or Status=‘Reservation Holding Period Expired’
292 Travel Segment Status=‘Awaiting Response’
294 Travel Segment Status=‘Awaiting Bids’ or Status=‘Awaiting Bid Selection’
296 Travel Segment Status=‘Reservation Accepted’
298 Travel Segment Status=‘Confirmed’
310 System Displays List of Potential Service Partners with their Fixed Cost for the Travel Segment
312 Traveler Selects One or more Service Partners for the Travel Segment
314 Traveler Chooses Pricing Option
316 Pricing Option?
318 Set Travel Segment Status to ‘Awaiting Reservation Response’
320 Send Travel Reservation Request to Service Partner
322 Set Travel Segment Status to ‘Awaiting Bids’
324 Send Travel Reservation Bid Request to Service Partner
326 Another Service Partner?
330 System Displays Status of Outstanding Reservation Request & Details
332 Traveler Selects Travel Segment Decision
334 Change Service Partner Selection?
336 Set Travel Segment Status to ‘New’
338 Cancel Travel Segment?
340 Set Travel Segment Status to ‘Canceled’
350 System Displays List of Selected Service Partners with their Bid Status for the Travel Segment
352 Traveler Chooses Bid Option
354 Pricing Option?
356 Send Travel Reservation Bid Acceptance to Service Partner
358 Set Travel Segment Status to ‘Awaiting Reservation Response’
360 Traveler Chooses Whether to Confirm Accepted Reservation
362 Confirm Reservation?
364 Send Travel Reservation Confirmation to Service Partner
366 Set Travel Segment Status to ‘Confirmed’
370 System Displays Status of Confirmed Reservation Request & Details
372 Travler Selects Travel Segment Decision
374 Change Service Partner Selection?
376 Send Travel Reservation Cancellation Notice to Old Service Partner
378 Set Travel Segment Status to ‘New’
380 Change Same Service Partner Information?
382 Luggage Status=‘Missed Cut-off Time’?
384 Set Luggage Status to ‘Baggage Handling’ for All Luggage in Luggage Set
386 Send Notice to mySkyCap Baggage Handling Personnel
390 Receive Travel Reservation Request Response
392 Retrieve Appropriate Travel Itinerary & Travel Segment
394 Travel Segment Canceled?
396 Response?
398 Set Travel Segment Status to ‘Reservation Accepted
400 Set Travel Segment Status to ‘Reservation Rejected’
402 Send Notification to Family Profile Owner of Receipt of Travel Reservation Response
410 Receive Travel Reservation Bid
412 Retrieve Appropriate Travel Itinerary & Travel Segment
414 Travel Segment Canceled?
416 Associate Travel Segment Reservation Bid with Appropriate Travel Segment
418 Send Notification to Family Profile Owner of Receipt of Travel Reservation Bid
420 Add Bids Received?
422 Set Travel Segment Status to ‘Awaiting Bid Selection’
430 Create List of Current Itinerary IDs
432 Retrieve l′ Current Itinerary
434 Retrieve 1^{st} Travel Segment
436 Determine Cut-off Time of Reservation Hold
438 Cut-off Time Passed?
440 Set Travel Segment Status to ‘Reservation Holding Period Expired’
442 More Segments?
444 Retrieve Next Travel Segment
446 More Itineraries?
448 Retrieve Next Itinerary
450 Family Member Chooses to Confirm an Itineary
452 mySkyCap Retrieves First Travel Segment
454 Travel Segment Confirmed?
456 More Travel Segments?
458 Retrieve Next Travel Segment
460 Display Travel Segment Not Confirmed Warning
470 Start Transaction Group
472 Set Itinerary Status to ‘Confirmed’
474 Retrieve 1^{st} Travel Segment
476 Set Travel Segment Status to ‘Awaiting Confirmation’
478 More Segments?
480 Retrieve Next Travel Segment
482 Display Itinerary Booking Confirmation
484 Stop Transaction Group
486 Transaction Group Successful?
488 Send Travel Segment Confirmation to Travel Partner
490 Roll Back Transaction
492 Log Transaction Error
500 Hotels
502 Car Rentals
504 Parking Facility
506 mySkyCap Services
508 mySkyCap Remote Unit
510 mySkyCap Mobile Unit
512 mySkyCap Base Facility
514 Shuttle
520 Luggage with RF Tag
522 RF Unit
524 Laptop/PC/Web Device
526 Bar Code Reader
528 Bag Tag Printer
530 Boarding Pass Printer
540 Travel Passenger Chooses to Check-in
542 Travel Passenger Provides Day of Departure Contact Data
544 Travel Passenger Checks in on Service Partner Site
546 Service Partner Sends a Travel Information Change Notice to mySkyCap
548 mySkyCap Receives Travel Information Change Notice
550 mySkyCap Stores Day of Departure Contact Data
552 Print Boarding Pass?
554 Print Boarding Passes for all Family Members on Travel Segment
560 Travel Family Visits Transportation Partner
562 Travel Family Registered with mySkyCap?
564 Service Partner Enters Travel Family's mySkyCap ID
566 Travel Family Authenticates?
568 Display Authentication Warning
570 Current Itinerary?
572 Create New Itinerary For Family
574 Appropriate Travel Segment?
576 Create New Travel Segment
578 Associate New Travel Segment with Itinerary
580 Service Partner Indicates Luggage Check-in
582 System Creates a New Luggage Set
584 Service Partner Takes 1^{st} Luggage
586 More Luggage?
588 Service Partner Takes Next Luggage
590 All Luggage Accounted for in Travel Segment
592 Display Luggage Unaccounted for Warning
594 System Asks if Luggage Should be Removed
596 Remove Luggage from Travel Segment
598 Remove Additional Luggage from Travel Segment
600 Save Luggage Set
602 Transport Luggage to Destination
610 Service Partner Examines Luggage for a mySkyCap RF Chip
612 Luggage has a mySkyCap RF Chip?
614 Attach Temporary mySkyCap RF Chip to Luggage
616 Service Partner Scans Luggage
618 Scan Problems?
620 Display Luggage Profile
622 Service Partner Performs Visual Inspection
624 Luggage Profile Matches Luggage?
626 Edit Luggage Profile
628 Set Luggage Status to ‘Service Partner Custody’
630 Set Custody to Service Partner
632 Add Luggage to Luggage Set
634 Print and Attach Luggage Tag
640 Set Luggage Status to ‘Scanning Issue’
642 RF Chip Associated with Luggage Theft?
644 RF Chip Associated with Another Family's Luggage Profile
646 Display Potential Theft Warning
648 Detain Luggage & Notify Authorities
650 Send Warning Notification to mySkyCap Customer Service
652 Set Luggage Status to ‘Issue Resolution’
660 RF Chip not Associated with any Luggage?
662 Display Blank Luggage Profile Form
664 Enter Luggage Profile Information
666 Associate Luggage Profile with Family Profile
668 Associate Luggage with Current Travel Segment
670 Luggage Associated with Current Travel Segment?
672 Ask to Associate Luggage with Current Travel Segment
674 Associate Luggage?
676 Return Luggage to Traveler
680 Service Partner Chooses to Make Transfer
682 System Displays List of Luggage Sets in Custody of Service Partner
684 Service Partner Selects 1^{st} Luggage Set
686 More Luggage Sets to Process?
688 Service Partner Selects Next Luggage Set
690 System Selects 1^{St} Traveler Associated with Luggage Set
692 System Sets Traveler's Status to ‘Idle’
694 More Travelers?
696 System Selects Next Traveler Associated with Luggage Set
700 Service Partner Seects Appropriate Transfer Action
702 Transfer to Another Transportation Partner?
704 Transfer to Owner?
706 Set Luggage Status to ‘Idle’
708 Set Custody to Owner
710 Transfer to mySkyCap Personnel?
712 Set Luggage Status to ‘Baggage Handling’
714 Set Custody to mySkyCap
720 Another Travel Segment in Itinerary?
724 System Displays Appropriate Travel Segment
726 Correct Service Partner to Hand-off?
728 Insert or Modify?
730 Create New Travel Segment
732 Set Travel Segment Status to ‘New’
734 Associate Travel Segment with Itinerary
736 Service Partner Confirms Transfer
738 System Sets Current Travel Segment to Next Travel Segment
740 mySkyCap Customer Service Receives Potential Theft Warning Message from Service Partner
742 mySkyCap Customer Service Representative Chooses to Resolve Issue
744 System Displays Luggage Profile of Current Luggage and Registered Luggage Associated with RF Chip
746 Resolve Which Profile is Correct
748 Correct Profile?
750 Send Potential Theft Notice to Service Partner
752 Send Luggage Resolution Notice to Service Partner
754 Set Luggage Status to ‘Idle’
760 mySkyCap Customer Service Receives a Call from Traveler about Missed Cut-off Time
762 Traveler Visits mySkyCap Service Desk
764 Traveler Provides mySkyCap Customer Service Their mySkyCap ID
766 mySkyCap Customer Service Accesses the Traveler's Secure Profile
768 mySkyCap Customer Service Authenticates Traveler
770 Travler Indicates Desired Service
772 Update Travel Segment?
774 Pick Up Luggage?
780 Traveler Provides New Information
782 mySkyCap Customer Service Updates Appropriate Travel Segment
784 mySkyCap Customer Service Indicates to System to Save Information
786 System Sets Luggage Status to ‘Baggage Handling’ for all Luggage in the Luggage Set
790 System Saves Updated Travel Segment
800 mySkyCap Customer Service Sends Message to mySkyCap Baggage Handling Personnel
802 mySkyCap Baggage Handling Personnel Bring Traveler's Luggage to mySkyCap Customer Service
804 mySkyCap Customer Service Gives Luggage to Traveler
806 mySkyCap Customer Service Indicates to System that Traveler Received Their Luggage
808 System Sets Luggage Status to ‘Idle’ for all Luggage
810 System Sets Luggage Custody to Owner
812 System Sets Travel Segment Status to ‘Completed’
820 Service Partner Changes the Traveler's Segment in their Separate System
822 mySkyCap Receives Travel Information Change Notice
824 mySkyCap System Retrieves Appropriate Itinerary & Travel Segment
826 mySkyCap System Updates Travel Segment Information
828 mySkyCap Sets Status of all Luggage in Luggage Set to ‘Baggage Handling’
830 Notice Sent to mySkyCap Baggage Handling Personnel
840 mySkyCap Common Use Sortation and Security System
842 mySkyCap RF Baggage Handling
844 mySkyCap RF Bag Tag System
846 CTX X-Ray Device
848 mySkyCap RF Sortation System
850 Baggage Reject
852 Airline
854 Resolution Bay
856 Flight
860 Luggage Arrives at RF Baggage Holding
862 Perform Visual Inspection of Luggage for RF Chip & Airline Baggage Tag
864 Luggage Has mySkyCap RF Chip?
866 Manually Resolve Unidentified Luggage
870 Luggage Has Bag Tag?
872 RF Unit Scans mySkyCap RF Chip on Luggage
874 Set Luggage Status to ‘Baggage Handling’ & Timestamp
876 Access Passenger Database to Determine Passenger Status
878 Passenger Performed Check-in?
880 Send Bag to CTX Cray Device
882 Put Luggage in Holding Area
884 Set Luggage Status to ‘Holding For Passenger Check-in’ & Timestamp
890 Set Luggage Status to ‘XRay Scanning’ & Timestamp
892 Perform Security Scan with CTX SRay Device
894 Pass Security Scan?
896 Put Luggage in Sortation Area
898 Set Luggage Status to ‘Delivering to Service Partner’ & Timestamp
900 Deliver Luggage to Appropriate Service Partner
902 Set Luggage Status to ‘Service Partner Custody’ & Timestamp
904 Put Luggage in Baggage Reject Area
906 Set Luggage Status to ‘Failed XRay Scan’ & Timestamp
908 Deliver Luggage to Appropriate Service Partner Resolution Bay
910 Set Luggage Status to ‘Luggage Resolution’ & Timestamp
912 Set Custody to Service Partner
920 Deliver Luggage to RF Bag Tag System Area
922 System Accesses Luggage Profile
924 Print Airline Baggage Tag
926 Attach Airline Baggage Tag to Luggage 928 mySkyCap Baggage Handling Personnel Deliver Luggage to CTX XRay Device
930 Create List of Luggage in Holding Area
932 Retrieve Luggage Profile of Luggage
934 Access Passenger Database to Determine Passenger Status
936 Passenger Performed Check-in?
938 Send Bag to CTX XRay Device
940 Determine Luggage Holding Time
942 Within Warning Time?
944 Send Warning Notification to Traveler
946 Past Cut-off Time?
948 Send Cut-off Time Notification to Traveler
950 Set Luggage Status to ‘Missed Cut-off Time’
952 More Luggage?
954 Retrieve Next Luggage Profile
960 Luggage Container
962 mySkyCap RF Container Sort System
964 Air Freighter
966 mySkyCap Ship Receiving Sortation System
968 Delivery Partner

### DETAILED DESCRIPTION OF THE PREFERRED EMBODIMENTS

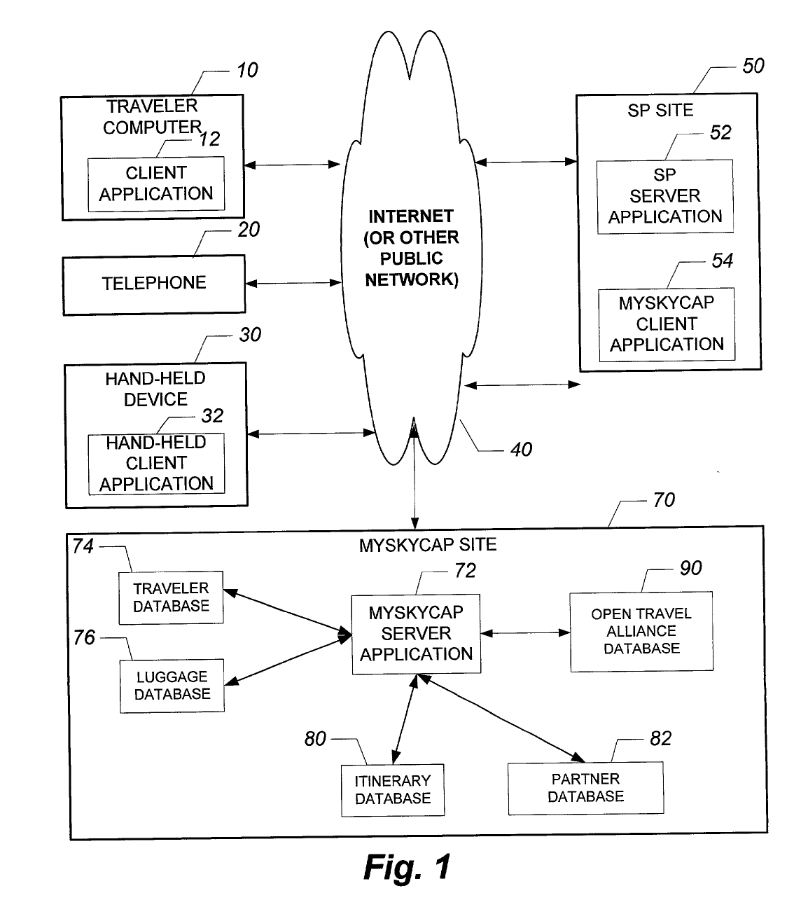

A preferred embodiment of the system architecture of the present invention is illustrated in FIG. 1.

### 1. Overview

The present invention involves a system and method for electronic passenger luggage handling services over a distributed network. The distributed network may be an unsecured public network such as the Internet. To make use of the MySkyCap transaction services, users must be pre-registered with the MySkyCap site. Any necessary software components will be made available. These software components, in combination with the MySkyCap site, preferable provide the following features:

1. One stop convenient location for pick-ups and drop-offs.
2. Ability to pickup luggage at passenger's home or office location prior to departure.
3. Ability to deliver luggage to passenger's destination in a secure and reliable manner.
4. A single centralized and secure repository of registrant profiles and transaction histories.
5. Eliminates Credit Card Fraud for service providers because the MySkyCap is responsible for payment collection. Thus service providers are guaranteed payment from the MySkyCap.
6. System which facilitates service providers bidding on individual travel segments of an itinerary.
7. Ability to put some travel segments out for bid.
8. Ability to have a mixture of fixed price and bid price travel segments in a single itinerary.
9. Allows for booking of reservations across multiple service partners whereby the process is guaranteed as a whole and only required to pay if all reservations are successful.

The system and method of the present invention are advantageously suited for use over a public network such as the Internet due to its widespread availability. (When used in herein in conjunction with “network”, the term “public” is intended to imply that user access to the network is not controlled by or limited to a particular business entity or group of business entities. Likewise, the term “distributed” implies that processing capabilities and services are spread out among different nodes of the network as opposed to being centralized within a single host, server or LAN—with different nodes providing different services.) In general, however, the system and method can be used on any type of distributed network over which online services are provided by Service Providers to end users, including both public and private, and hybrid public-private networks.

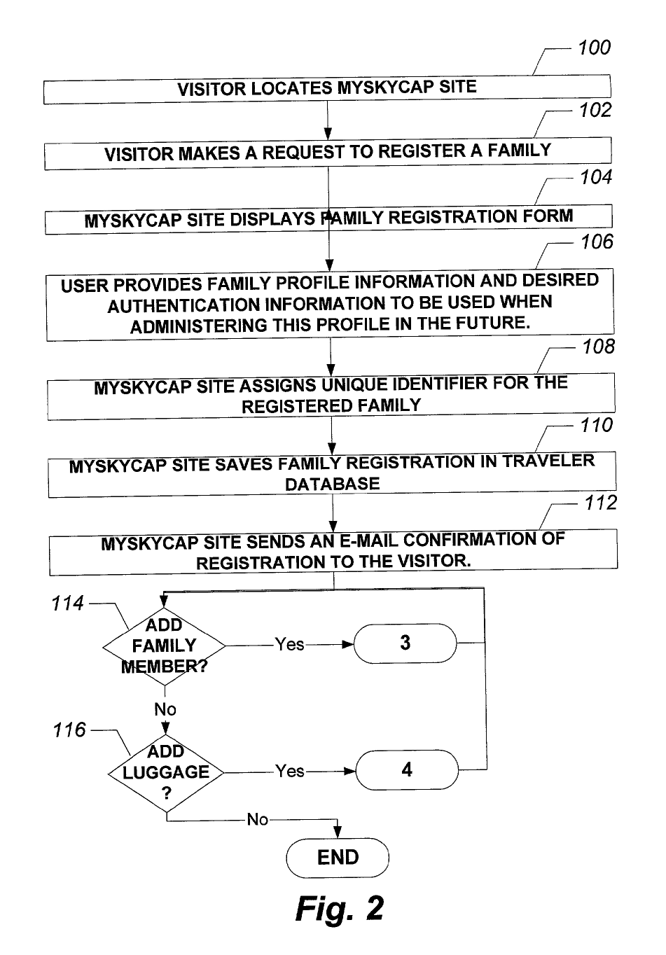

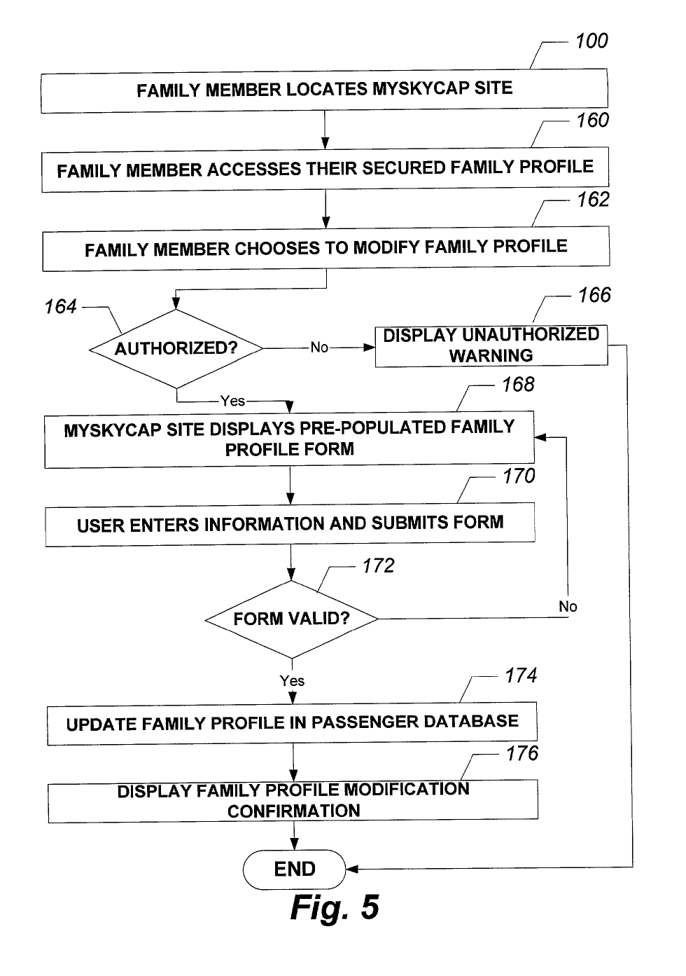

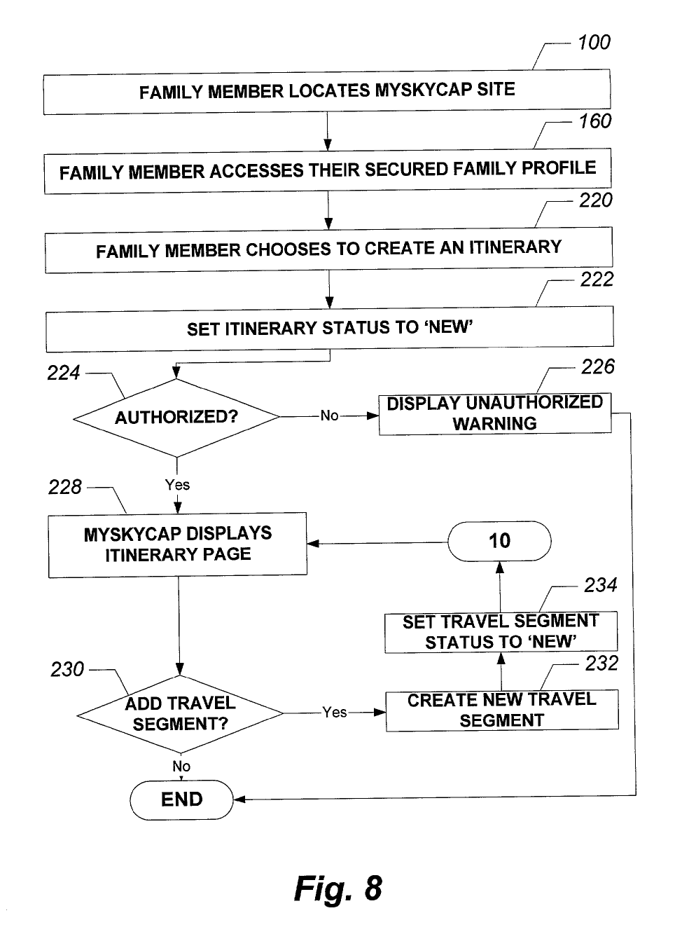

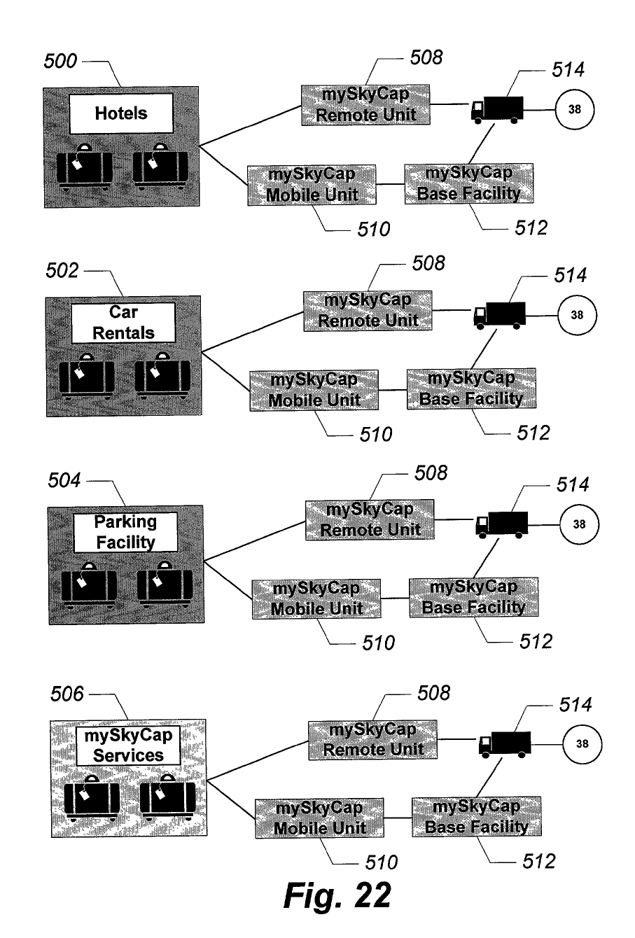

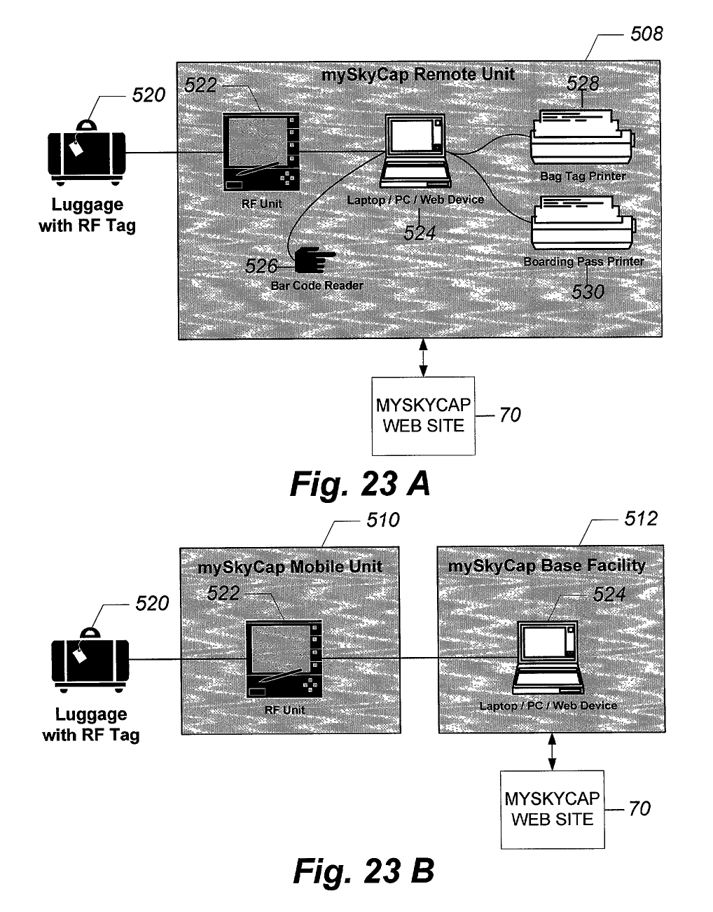

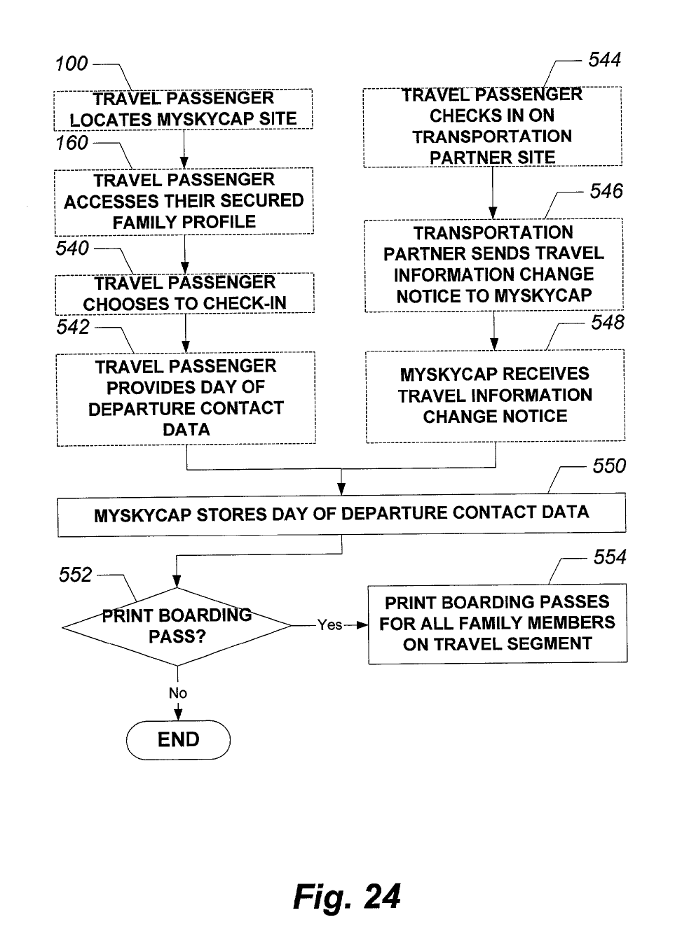

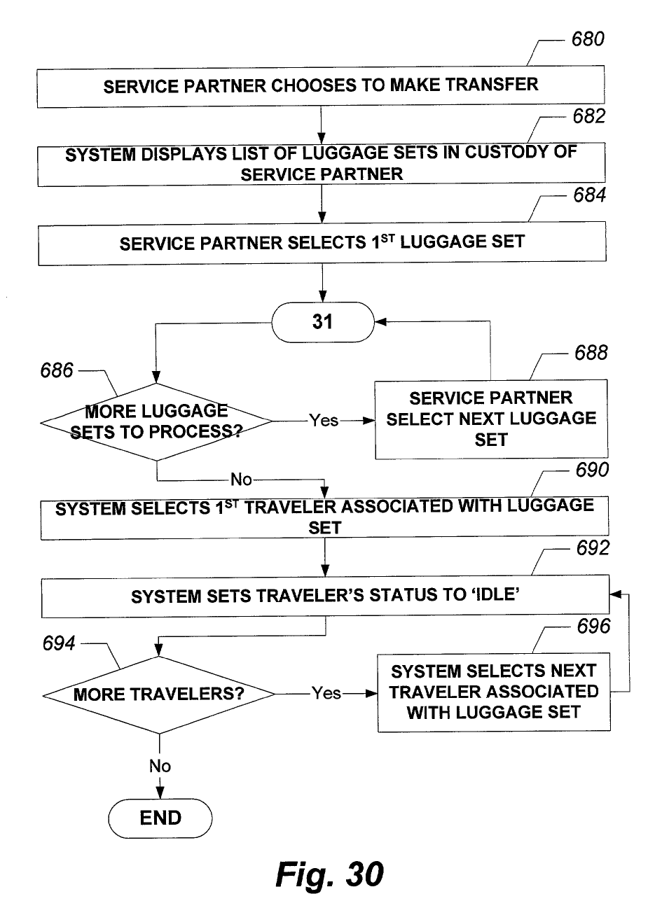

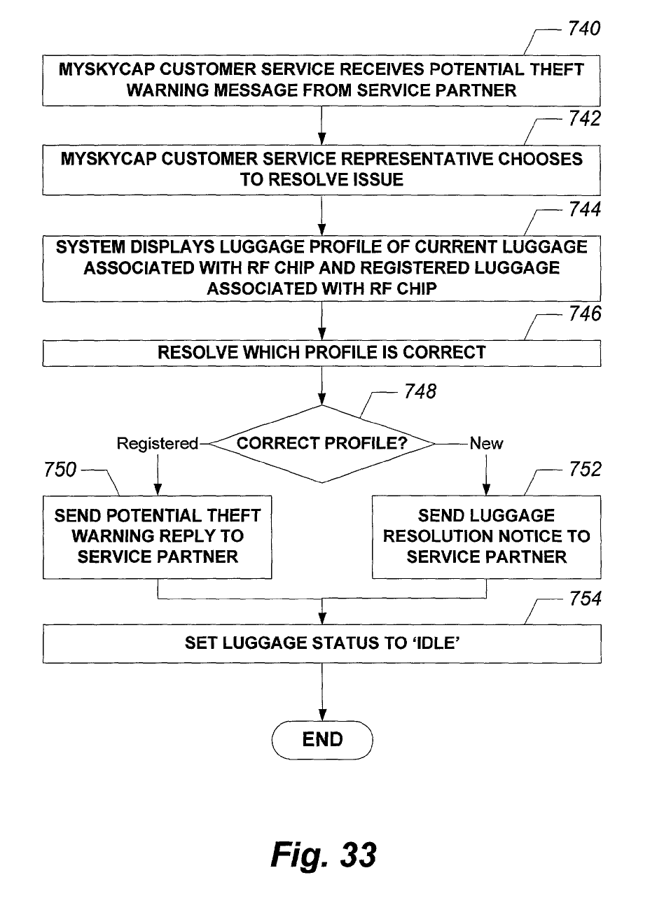

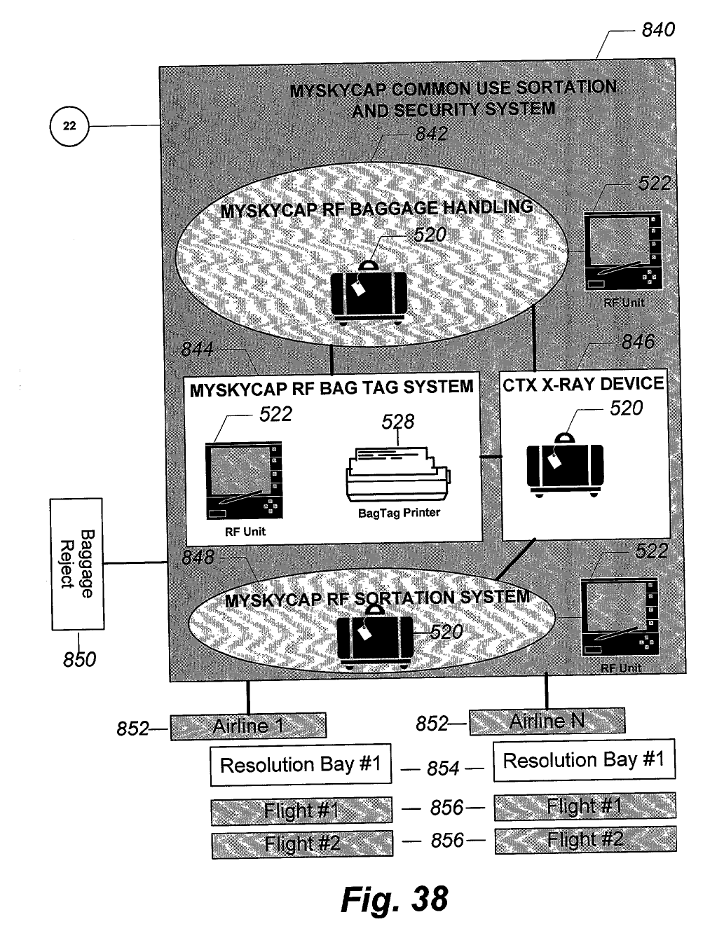

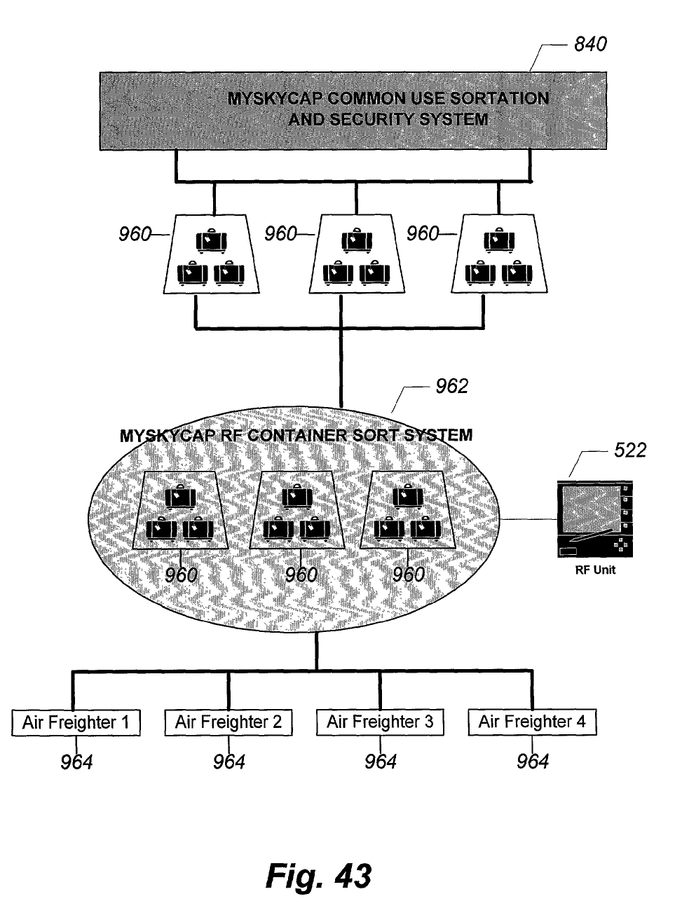

To facilitate a complete understanding of invention, the remainder of the detailed description is arranged as follows: The basic components and features of the preferred embodiments will be initially be described with reference to FIG. 1 under the heading GENERAL ARCHITECTURE. Registration of Families, Family Members, and luggage will be described with reference to FIGS. 2-4 under the heading FAMILY REGISTRATION PROCESSES. The processes for maintaining family profiles, family member profiles, and luggage profiles are described with reference to FIGS. 5-7 under the heading PROFILE MAINTENANCE PROCESSES. The processes for creating travel itineraries, along with corresponding travel segment reservations are described with reference to FIGS. 8-21 under the heading ITINERARY & RESERVATION PROCESSES. The architecture of mySkyCap partners is described with reference to FIGS. 22-23 under the heading MYSKYCAP PARTNER ARCHITECTURE. The check-in processes are described with reference to FIGS. 24-29 under the heading CHECK-IN PROCESSES. The transfer process is described with reference to FIGS. 30-32 under the heading MYSKYCAP PARTNER TRANSFER PROCESSES. The mySkyCap Administration Handling Processes are described with reference to FIGS. 33-37 under the heading MYSKYCAP ADMINISTRATION HANDLING PROCESSES. The processes of handling luggage at airport facilities are described with reference to FIGS. 38-42 under the heading MYSKYCAP AIRPORT HANDLING PROCESSES. The communication messages are described with reference to FIG. 43 under the heading COMMUNICATION PROCESSES.

### 2. General System Architecture (FIG. 1)

FIG. 1 illustrates the basic components of a system, which operates in accordance with the present invention. Registered users (also referred to as “customers”, “passengers”, or “travelers”) connect to the Internet 40 (or other distributed public network) via either user computers 10, telephones 20, or hand-held devices 30 (e.g. Palm and Windows CE devices) to perform transactions, modify their personal profile, or receive solicited notifications from SP sites 50. SP sites 50 communicate with the MySkyCap site 70 to transact with a registrant.

The registered users may connect to the Internet 40 in any known manner. For example, the users may use a suitable online services network to obtain access to the Internet, or may connect by establishing an account with an Internet Service Provider (not shown). Each user computer 10 includes at least one client application 12 (such as a World Wide Web browser) for communicating with server application 72 on the Internet 40.

The SP services are provided on the individual SP sites 50 of registered Partners. Each SP site 50 will typically comprise one or more physical servers that are connected to the Internet 40. Each SP site 50 runs at least one server application 52 for providing an online service. A given SP site 50 may, of course, provide multiple online services. Some of these services may be non-transaction-related services that are provided for free. For purposes of the following description, it may be assumed that the term “SP service” refers only to transaction-based services. Additionally, it may be assumed that the term “Registrant”, and the term “Service Partner” refers only to registered users, and SPs respectively. Likewise, the terms ‘Passenger’, ‘Traveler’, and ‘Customer’ are used interchangeably. The terms “visitor” and “user” may refer to registered users or non-registered users.

Although the user computers 10 and the SP sites 50 are shown as being directly connected to the Internet 40, it should be understood that such connection may be via one or more private networks. For example, a user computer 10 may connect to the Internet 40 via a wireless connection or via a private cable televisions network using a cable modem. Likewise, an SP 50 site may connect to the Internet via a private network of the merchant's organization.

Similar to user computers 10, passengers may also access the mySkyCap site 70 via either a telephone 20 (either land line or wireless) or through the use of a hand-held device 30. The preferred embodiment for the telephone 20 would be a toll-free automated phone system for making and canceling reservations, and checking on the status of luggage. The hand-held devices 30 would have at least one PDA client application 32 such (such as a WAP-enabled browser) for communicating with server application 72 on the Internet 40.

SP sites 50 may offer various types of services. These services may include retail merchandise, as well as digital products and/or informational or subscription-based services or wholesale purchases. For example, one SP may offer services such Ticketing, while still another one the sale of products for passengers such as suitcases. Other SP services may include, travel gadgets, audio books and tapes, travel videos and books, or other services for the traveler such as taxies or limos.

With reference to FIG. 1, each SP site 50 additionally includes a MySkyCap Client Application 54, which initiates transactions with the MySkyCap Server Application 72. The MySkyCap Client Application 54 components are preferable in the form of software modules, which include the necessary logic for sending the items in an encrypted format to the MySkyCap Server Application 72. These software components may also contain information requests. The preferred embodiment of this information is in the form of XML (extensible Markup Language), which is becoming popular for business-to-business communication in the industry.

With further regards to FIG. 1, The MySkyCap site 70 preferably comprises one or more physical servers that run a MySkyCap Server application 72 to implement the MySkyCap Service. The site 70 is preferably operated by a single business, or a small collection of businesses, that are qualified to perform secure transactions on behalf of users and SPs. As described below, the MySkyCap Site 70 may communicate with the SP sites 50 either via the Internet (or other public network), a private network, a private communications channel, or a combination thereof. The centralized MySkyCap site 70 will maintain the operations of multiple physical franchisee locations. An alternative embodiment would be for multiple sites to handle multiple physical locations to accommodate franchise operations.

Although a single MySkyCap site 70 is shown in FIG. 1, it will be recognized that multiple MySkyCap sites could be provided on the Internet 40. For example, MySkyCap sites may be set up at several different geographical locations to accommodate SP sites 50 located in different countries and to distribute the load. Additionally, as with the user computers 10, the telephones 20, the hand-held devices 30, the SP sites 50, the MySkyCap site 70 may be connected to the Internet 40 via one or more private networks.

The MySkyCap site 70 includes one or more physical databases for storing various account information with respect to the passengers and service providers. The traveler database 74 would contain membership information such as passwords, profiles, and financial information and keep track of all transactions associated with that passenger. The luggage database 76 would contain information such as brand, size, color, etc. and unique luggage tracking IDs. The itinerary database 80 would store all the travel itineraries and travel segment reservation information. The partner database 82 would store business rules and information unique to transportation entities such as airlines, car rentals, cruise ships, trains, buses, and shuttles. For example, airlines might want to show different and unique data on our rendering of their bag tag or boarding pass. The Open Travel Alliance database 90 contains all the business rules on how the alliance partners talk with each other via the Internet. The preferred embodiment of the communication between alliance partners is using XML (eXtensible Markup Language).

Note that this invention does not limit the information that may be contained in these databases, but only defines the minimum information that must be provided.

Finally, the MySkyCap site 70 may save, and make available to the SPs, certain aggregate marketing information that can be used to tailor their respective services and products.

### 3. Family Registration Processes (FIGS. 2-4)

FIG. 2 illustrates the basic steps that take place, in accordance with the invention, when a family registers at the MySkyCap site 70.

With reference to block 100 in FIG. 2, the visitor initially locates the MySkyCap Service by obtaining the location information of the corresponding MySkyCap site 70. This location information may be in a variety of forms, such as a Uniform Resource Locator (URL), a Domain Name Service (DNS) name, or an Internet Protocol (IP) address.

With reference to block 102, if a visitor makes a request to register with the MySkyCap system, the system displays 104 the Family Registration Form. They then provide 106 family profile information and a list of mySkyCap cities that are anticipated to be used and their preferred locations and SPs. In addition they also provide an associated password and password hint to be used when accessing their profile in the future. The password hint is displayed to the user if they forget their password. If they are still unable to login to their profile, they can request that an email message be sent to their registered email address with the associated password. This is a standard practice used by online sites to assist the user in remembering their password for access to the site. The MySkyCap system assigns 108 a unique identifier to be used later for identification and authentication. Upon the storing 110 of the new registrant profile in the traveler database 74, the MySkyCap system will send 112 an e-mail confirmation of the registration to the user.

The profile information will contain a customer name, address, city, state, zip, and email at a minimum, but may also contain additional information such as home and office phone and payment information. Forms of payment will initially include credit cards but will be expanded to include other electronic means such as company purchase orders, digital cash, stored-value cards, and other payment instruments that are deemed appropriate.

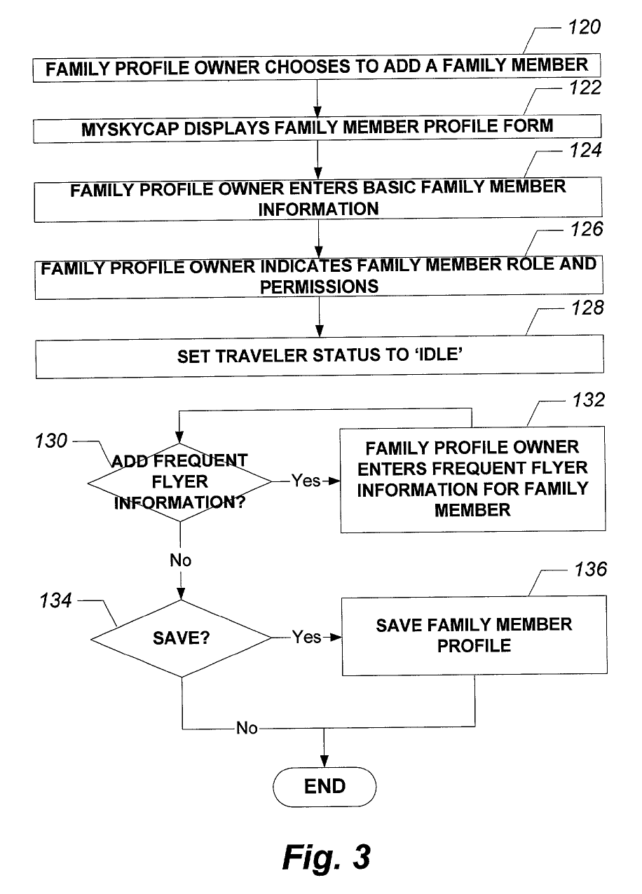

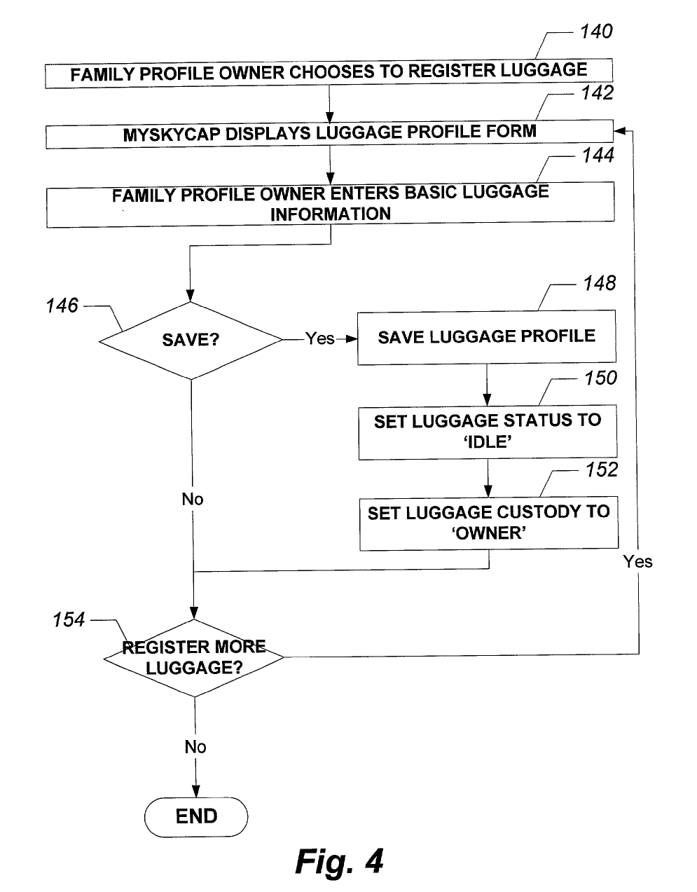

The registrant may optionally choose to add 114 family members and/or add 116 luggage to their family profile or wait to a more convenient time. If they choose to add 114 a family member, then the process continues with FIG. 3. Otherwise, if they choose to add 116 luggage to their family profile, then the process continues with FIG. 4. If instead, they choose to end the registration, then this process is completed.

With regards to FIG. 3, the owner of the family profile, or someone with the appropriate permission, chooses 120 to add a family member to the family profile. Next, mySkyCap displays 122 a Family Member Profile form from which the family profile owner enters 124 basic information such as their name, date of birth, contact information, and optional medical information. Next, the family profile owner indicates 126 any roles or permissions that this family member is allowed to play or exercise. Examples of roles might be profile owner or travel participant. Examples of permissions might be whether they can modify family member profiles other than themselves, whether they can modify their own profile, whether they can create a travel itinerary, or whether they can create their own wish lists. Note that these examples of roles and permissions are not meant to be exhaustive. Next, the system sets 128 the traveler's status to ‘Idle’. At this point, the profile owner may choose 130 to add frequent flyer information for the family member. If they so choose, then the profile owner enters 132 the appropriate frequent flyer information. The profile information will contain at a minimum the following for each travel program that they are a member of: airline/travel partner name; frequent flyer number; frequent flier tier level; and mySkyCap cities used. The profile owner may choose to enter as many frequent flyer programs as they want. Once the profile owner has completed entering any frequent flyer information, they may choose to either save the information or cancel the operation. If they choose to save 134 the information, then the system saves 136 the member profile in the traveler database 74. Otherwise, the process is completed.

With regards to FIG. 4, the owner of the family profile, or someone with the appropriate permission, chooses 140 to register a piece of luggage. The mySkyCap site then displays 142 the Luggage Profile form from which the profile owner enters 144 the basic luggage information. The luggage profile information will contain at a minimum the following for each piece of luggage that they want to register: bag brand; bag size; bag type; bag color. It may also contain information such as comments and damage status. The user will then have the option of saving 146 the luggage information or not. If they choose to save 146 the information, then the system saves 148 the luggage information to the luggage database 76. Next, the system sets 150 the luggage status to ‘Idle’ and sets 152 the custody of the luggage to ‘Owner’. Whether they choose to save or cancel, they are then given the option 150 of registering more luggage. If they choose 154 to register addition pieces of luggage, then the process is repeated starting with the system displaying 142 a luggage profile form. Otherwise, the process is completed.

### 4. Profile Maintenance Processes (FIGS. 5-7)

FIG. 5 shows the process for a visitor to update their family profile. They must first locate 100 the MySkyCap Site 70. This may be from search engines, reciprocal links, Emails, or other forms of advertising. The visitor then must access 160 their secured family profile. Then, if the visitor chooses 162 to modify their family profile, the system checks 164 to see if they are authorized. If they are not authorized, then the system displays 166 an unauthorized warning and completes the process. If they are authorized, then the system displays 168 a pre-populated Family Profile form from which the user enters 170 the appropriate information and submits the form. At this point, the system checks 172 to see if the form is valid or not by checking for required fields and the form passes all validation rules. If the information is not complete and correct, the user will be shown appropriate error messages and be given another chance to correct the information. Otherwise, if the form is valid, then the system will update 174 the family profile in the traveler database 74. The system then displays 176 a Profile Modification Confirmation page for the user.

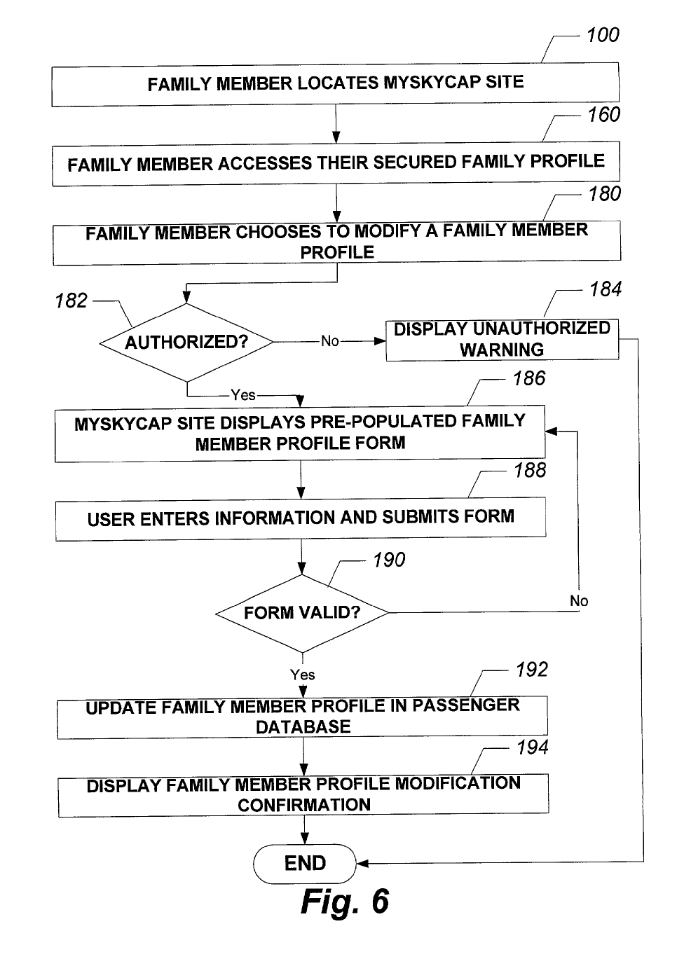

The family member profile modification, shown in FIG. 6, follows a similar flow as the family profile modification. After the family member locates 100 the mySkyCap site 70 and accesses 160 their secured family profile, they choose 180 to modify a family member profile, which may or may not be their own family member profile. The system checks 182 to see if they are authorized to modify the selected family member profile. Note that based on their permissions which were established by the profile owner, the family member may not even have access to modify their own profile. If they are not authorized, then the system displays 184 an unauthorized warning and completes the process. If they are authorized, then the system displays 186 a pre-populated Family Member Profile form from which the user enters 188 the appropriate information and submits the form. At this point, the system checks 190 to see if the form is valid or not. If the information is not complete and correct, the user will be shown appropriate error messages and be given another chance to correct the information. Otherwise, if the form is valid, then the system will update 192 the family member profile in the traveler database 74. The system then displays 194 a Profile Modification Confirmation page for the user.

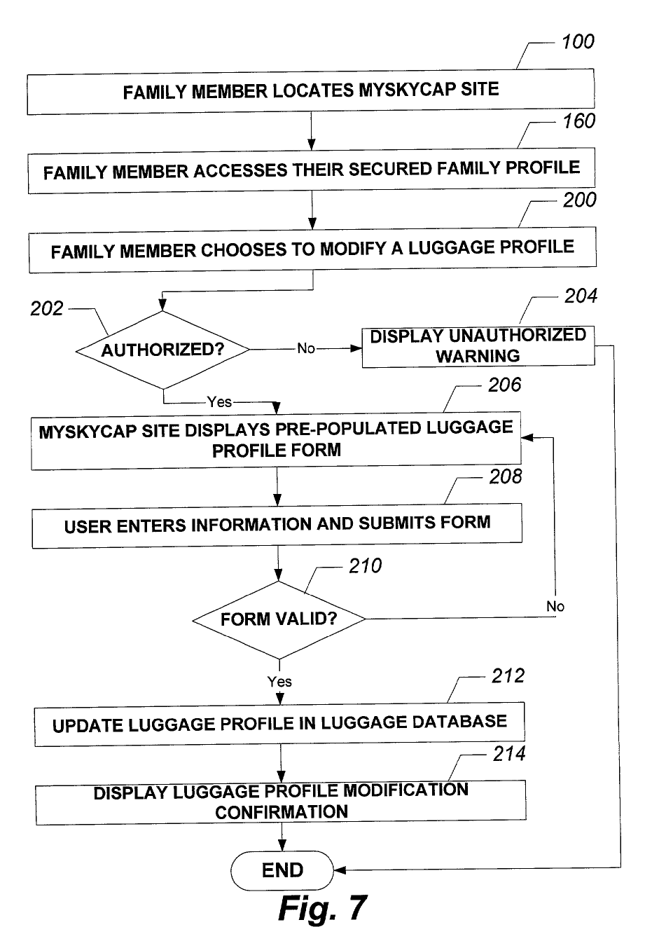

Similarly to FIG. 5 and FIG. 6, FIG. 7 shows the process for modifying luggage profiles. After the family member locates 100 the mySkyCap site 70 and accesses 160 their secured family profile, they choose 200 to modify a luggage profile. The system checks 202 to see if they are authorized to modify the selected a luggage profile. If they are not authorized, then the system displays 204 an unauthorized warning and completes the process. If they are authorized, then the system displays 206 a pre-populated Luggage Profile form from which the user enters 208 the appropriate information and submits the form. At this point, the system checks 210 to see if the form is valid or not. If the information is not complete and correct, the user will be shown appropriate error messages and be given another chance to correct the information. Otherwise, if the form is valid, then the system will update 212 the luggage profile in the luggage database 76. The system then displays 214 a Profile Modification Confirmation page for the user.

### 5. Itinerary & Reservation Processes (FIGS. 8-21)

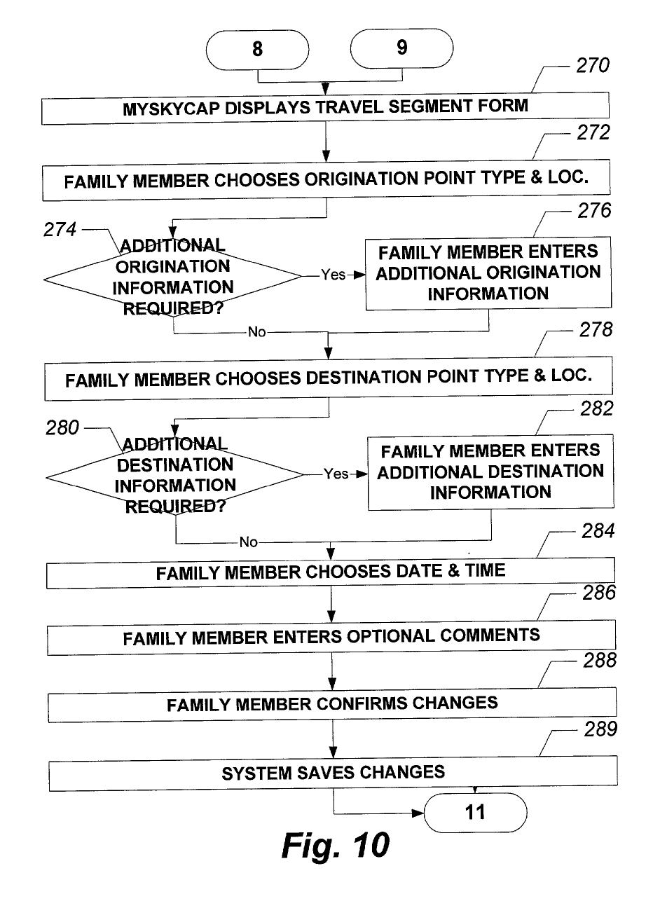

FIG. 8 shows the process whereby a travel member may create an itinerary, which consists of multiple reservations for travel segments. They begin the process by locating 100 the mySkyCap site and accessing 160 their secured family profile. Once authenticated, the family member chooses 220 to create an itinerary. Next the system sets 222 the itinerary status to ‘New’. The system then checks 224 to see if they are authorized to create an itinerary for this family profile. If they are not authorized, then the system displays 226 an unauthorized warning and completes the process. If they are authorized, then the system displays 228 an itinerary page. At this point, the user may add multiple travel segment reservations. If they choose 230 to add a travel segment reservation, then the system creates 232 a new travel segment and sets 234 the status of the travel segment to ‘New’. The process then continues with FIG. 10. Once the process in FIG. 10 is completed, processing returns to FIG. 8 and repeats the process with step 228. Once there are no more segments to add to the itinerary, the process is complete.

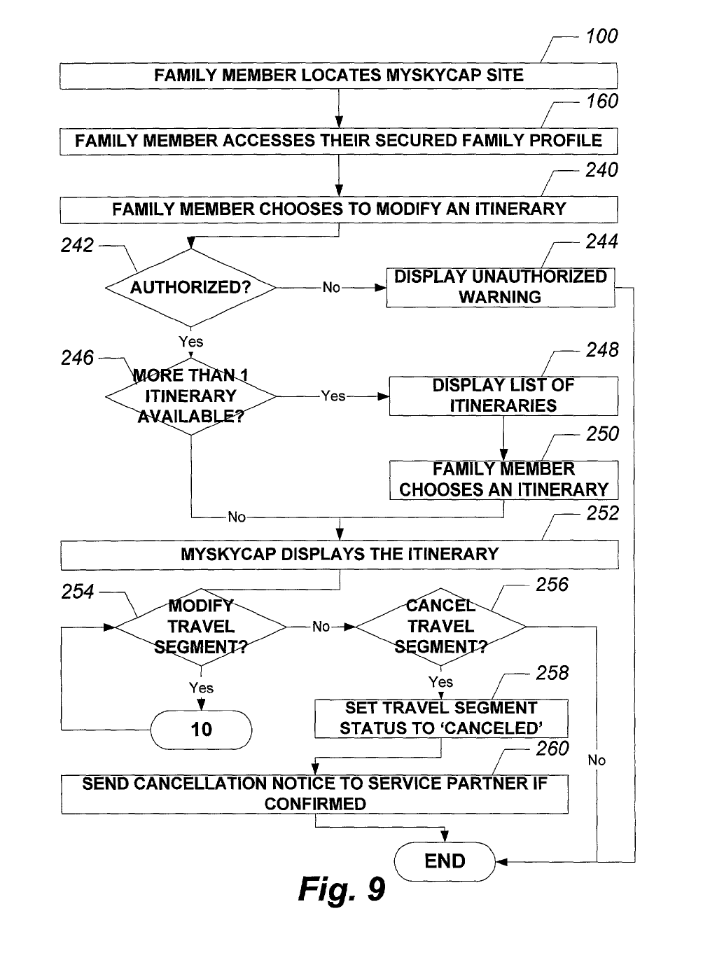

FIG. 9 shows the process of modify an existing itinerary. The process begins by the family member locating 100 the mySkyCap site and accessing 160 their secured family profile. The family member chooses 240 to modify an itinerary. The system checks 242 to see if they are authorized to modify an itinerary. If they are not authorized, then the system displays 244 an unauthorized warning and completes the process. If they are authorized, then the system checks 246 to see if there is more than one itinerary that as been created for this family profile. If there is more than one itinerary, then the system displays 248 a list of the itineraries from which the family member chooses 250 one. After a single itinerary is selected, mySkyCap displays 252 the selected itinerary. At this point, the family member can modify as many travel segments as desired. If they choose 254 to modify a travel segment, the process continues with FIG. 10. Otherwise the system determines 256 if the traveler wants to cancel the travel segment, then the system sets 258 the travel segment to ‘Canceled’ and sends 260 a cancellation notice to the travel partner if appropriate and then ends. If the traveler does not want to delete the travel segment, then the process is complete.

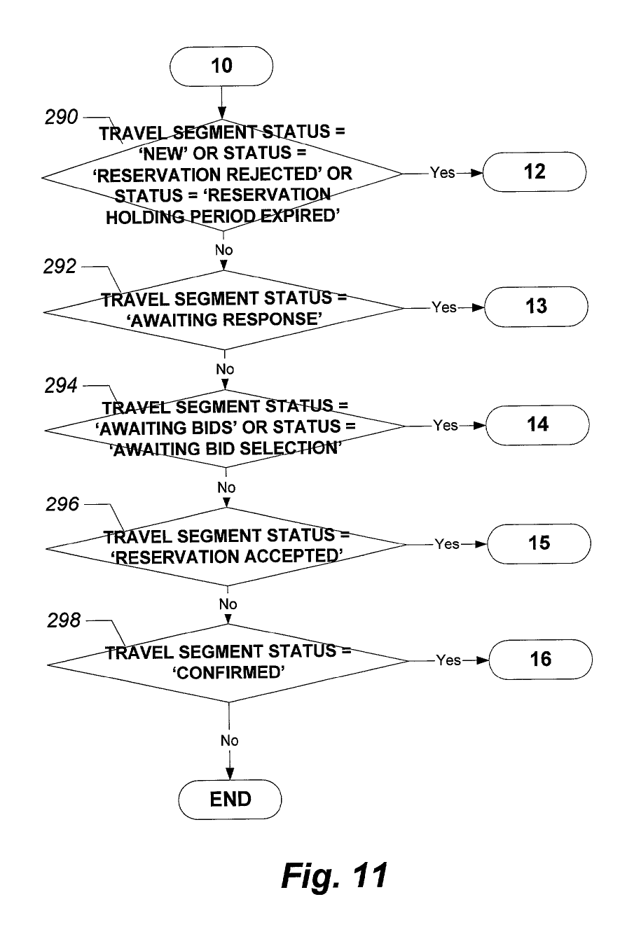

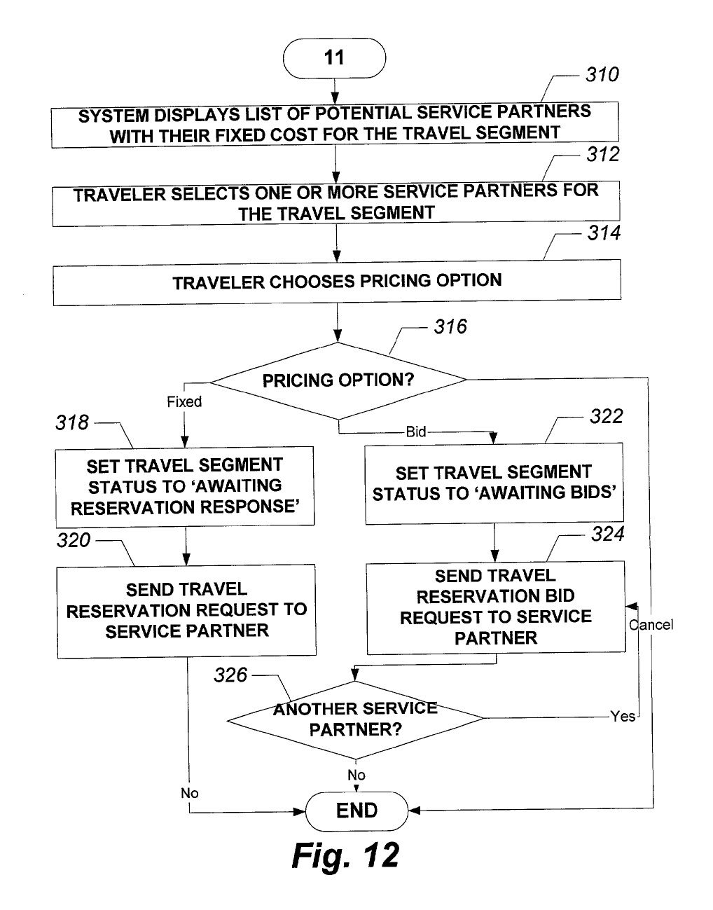

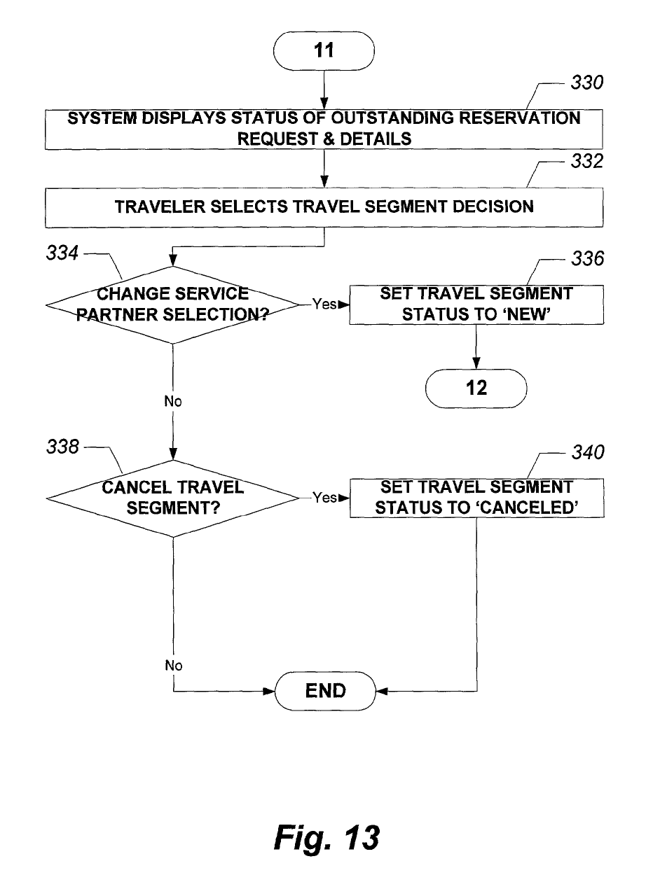

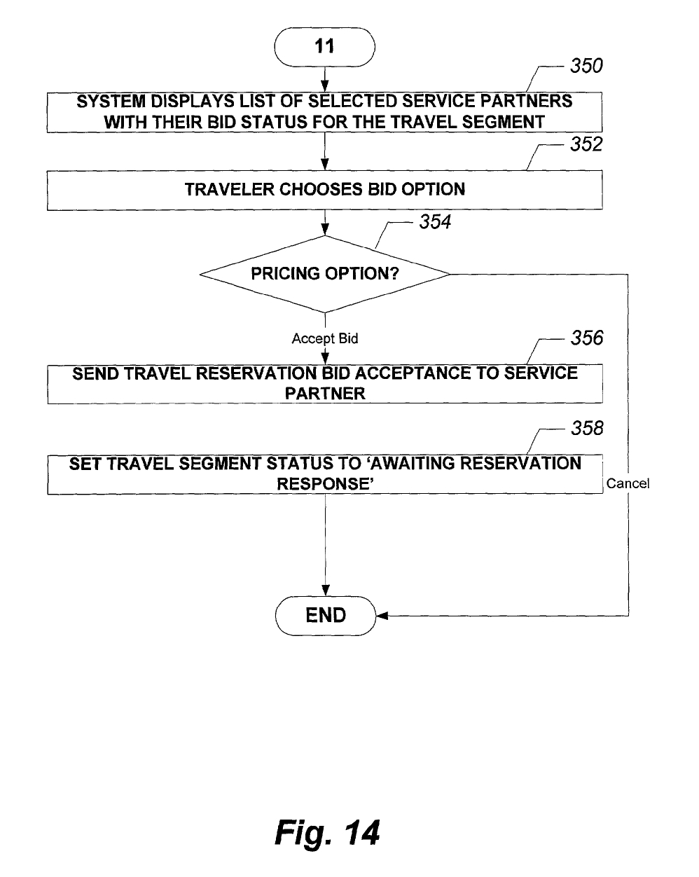

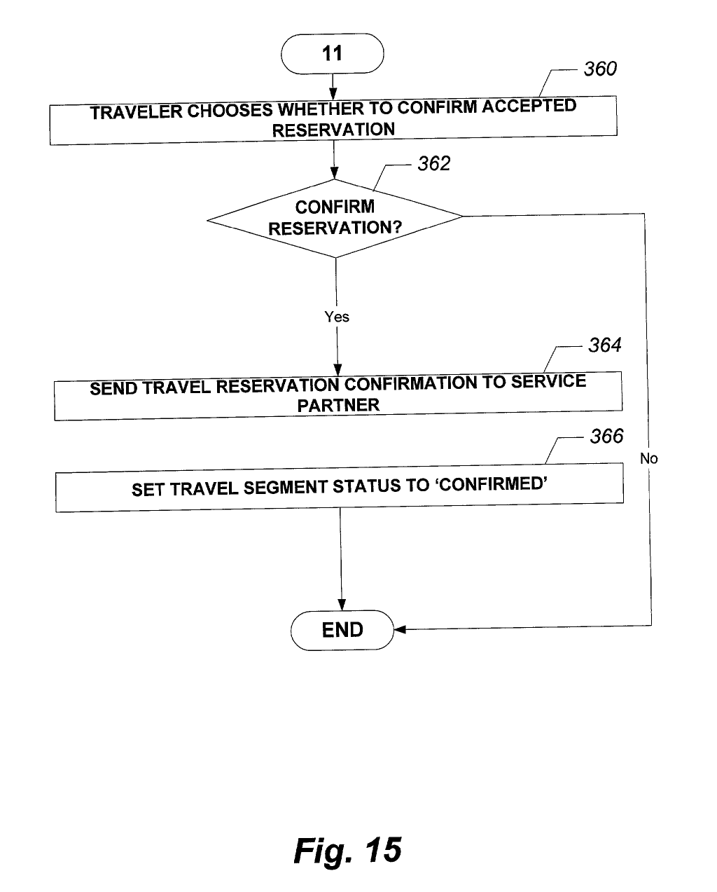

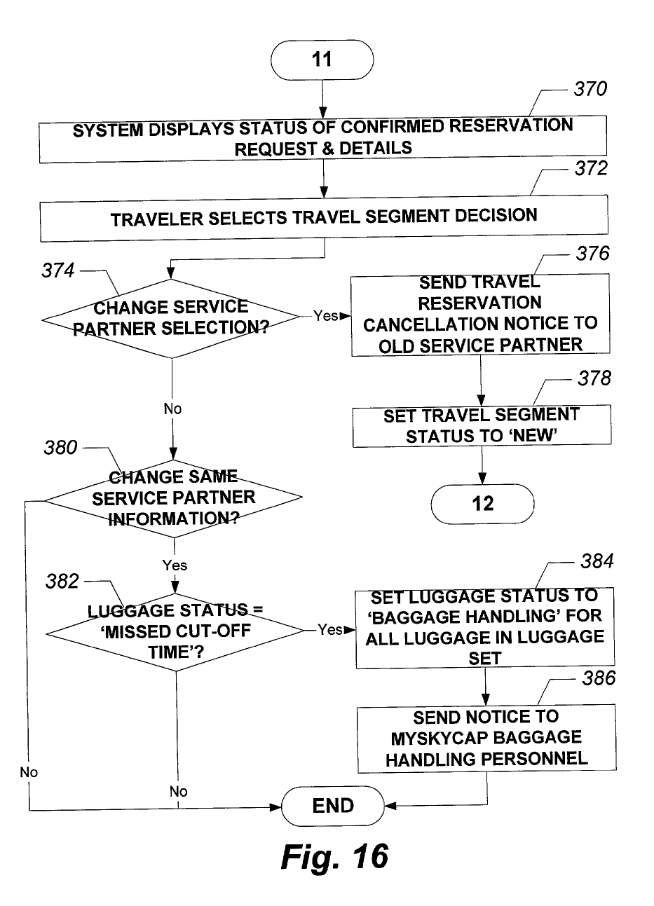

The travel segment reservation process is shown in FIG. 10. First, the system displays 270 the Travel Segment form. Next, the family member chooses 272 an origination point type and location. Examples of point types include airports, bus terminals, train stations, cruise ports, office locations, homes, rental lots, or parking lots. Then depending upon the point type selected, the user would be presented with a list of locations to choose from. For example, if they had previously selected a point type of ‘airport’, then they would now be presented with a list of airports from which they would choose. Next, the system determines 274 if additional information is required such as an address. For example, if the origination point is a known airport, then the system already has the address and doesn't require additional information. But, if the origination point is a family's house, then they system needs the address. If more information is necessary, the family member enters 276 the appropriate origination information. Next, the process continues with choosing 278 the destination point type and location in a similar method as the origination point type and location. Just like before, if the system determines 280 that additional destination information is required, then the user must enter 282 this additional information. Next, the family member chooses 284 the date and time of the desired reservation and optionally enters 286 any comments that they would like stored with the travel segment such as special handling notes. Once the family member confirms 288 the changes, the system saves 289. The process continues with FIG. 11 where the system takes different branches depending upon the status of the travel segment. If the travel segment status is determined 290 to be either ‘New’, ‘Reservation Rejected’, or ‘Reservation Holding Period Expired’, then the process continues with FIG. 12. Otherwise, if the travel segment status is determined 292 to be ‘Awaiting Response’, then the process continues with FIG. 13. Otherwise, if the travel segment status is determined 294 to be ‘Awaiting Bids’ or ‘Awaiting Bid Selection’, then the process continue with FIG. 14. Otherwise, if the travel segment status is determined 296 to be ‘Reservation Accepted’, then the process continues with FIG. 15. Otherwise, if the travel segment status is determined 298 to be ‘Confirmed’, then the process continues with FIG. 16.

In FIG. 12, the system begins by displaying 310 a list of potential service partners with their fixed cost for the travel segment. Note, future embodiments may filter this list based on user preferences, such as preferred partners. From this list, the traveler selects 312 one or more service partners for the travel segment and then chooses 314 the pricing option. If it is determined 316 that the traveler choose the fixed price, the system sets 318 the travel segment status to ‘Awaiting Reservation Response’ and sends 320 a travel reservation request 322 is sent to the service partner. Otherwise, if the traveler chose the bid pricing option, then the system sets 322 the travel segment status to ‘Awaiting Bids’ and sends 324 a travel reservation bid request to the first service partner selected. If it is determined 326 that there are more service partners, then the process repeats by sending 324 a travel reservation bid request to all selected service partners.

FIG. 13 shows the process when the travel segment status is ‘Awaiting Response’. It begins by the system displaying 330 the status of all outstanding reservation requests and details. Next, the traveler selects 332 a travel segment decision. The system then determines 334 whether the traveler has chosen to change the service partner and if so, sets 336 the travel segment status to “New” and continues with FIG. 12. Otherwise, if it is determined 338 that the traveler chose to cancel the travel segment, then the system sets 340 the travel segment status to ‘Canceled’. Note, that only individuals with the proper permission can cancel travel segments.

FIG. 14 shows the process when the travel segment status is either ‘Awaiting Bids’ or ‘Awaiting Bid Selection’. It begins by the system displaying 350 the list of selected service partners with their bid status and bid for the travel segment. Some examples of bid statuses might be ‘NA’, ‘Declined’, ‘Tentative’, or ‘Accepted’. Next, the traveler chooses 352 a bid option of either accepting one or canceling the operation. If it is determined 354 that the traveler accepted a bid, then the system sends 356 a reservation bid acceptance to the appropriate service partner. Next, the system sets 358 the travel segment status to ‘Awaiting Reservation Response’ and ends the process.

FIG. 15 shows the process when the travel segment status is ‘Reservation Accepted’. It begins by the traveler choosing 360 to confirm the accepted reservation. If it is determined 362 that the reservation is confirmed, then the system sends 364 a travel reservation confirmation to the service partner and sets 366 the travel segment status to ‘Confirmed’.

FIG. 16 shows the process when the travel segment status is ‘Confirmed’. It begins by the system displaying 370 that status of the confirmed reservation request and details. Next, the traveler selects 372 a travel segment decision. If it is determined 374 that the traveler changed the service partner selection, then the system sends 376 a cancellation notice to the old travel partner and sets 378 the travel segment status to ‘New’. It then continues with FIG. 12. Otherwise, if it is determined 380 that only information about the same service partner changes, then the system determines 382 if the luggage status is ‘Missed Cut-off Time’. If the luggage status is ‘Missed Cut-off Time’, then the system sets 384 the luggage status to ‘Baggage Handling’ and sends 386 a notice to the mySkyCap Baggage Handling personnel.

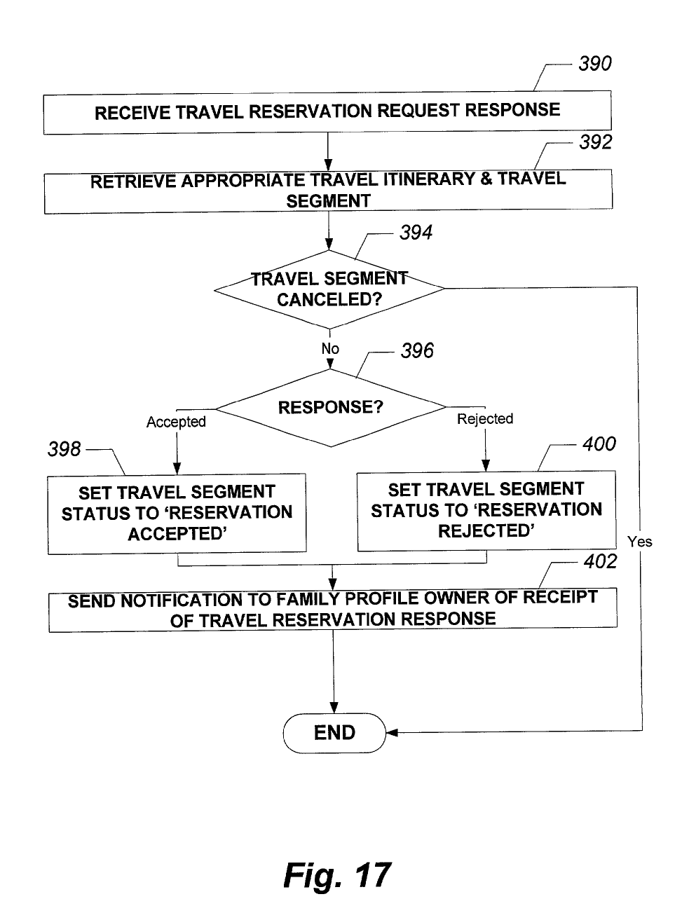

FIG. 17 shows the process that they system follows upon receiving a reply back from a travel reservation sent to a travel partner. First, the system receives 390 the travel reservation response and then retrieves 392 the appropriate travel itinerary and travel segment. Next, the system determines 394 if the segment has been previously canceled and if so, ends the process. Then the system determines 396 whether the service partner has accepted or rejected the reservation request. If the reservation is accepted, then the system sets 398 the travel segment status to ‘Reservation Accepted.’ Otherwise, the system sets 400 the travel segment status to ‘Reservation Rejected.’ The process ends by the system sending 402 a notification to the family profile owner of the receipt of a travel reservation request.

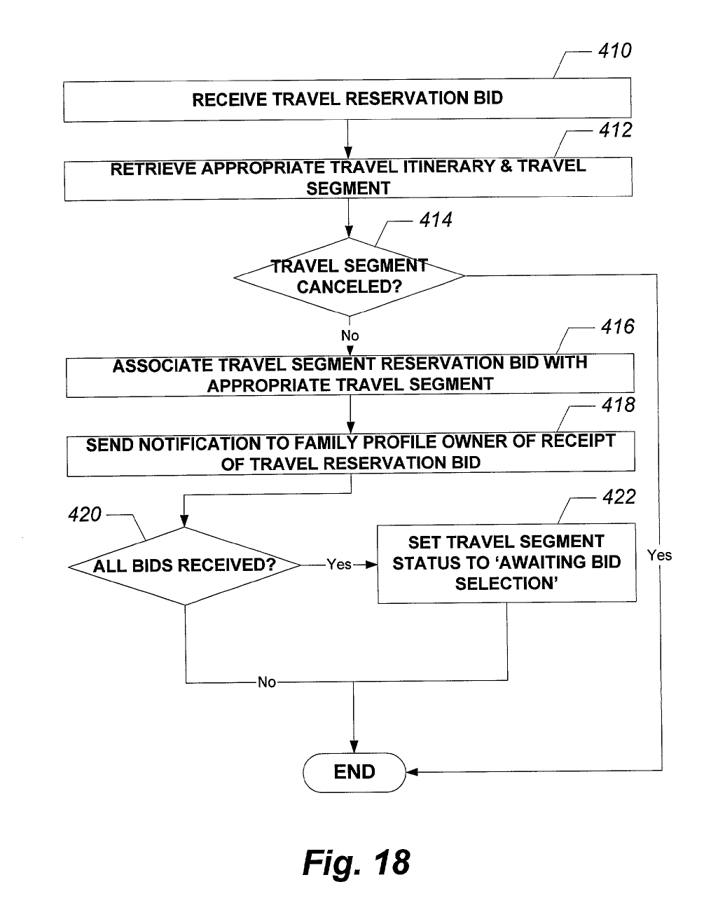

FIG. 18 shows the process that the system follows upon receiving a reservation bid from the service partner. The process begins receiving 410 a reservation bid. After, the appropriate travel itinerary and travel segment is retrieved 412, the system determines 414 whether the traveler has already canceled this travel segment. If so, then the process ends. Otherwise, the system associates 416 the travel segment reservation bid with the appropriate travel segment. Next, the system sends 418 a notification to the family profile owner of the receipt of a travel segment reservation bid. If the system determines 420 that all of the bids have been received, then it sets 422 the status of the travel segment to ‘Awaiting Bid Selection’ and ends. Otherwise, if all of the bids have not been received then the process ends with no further transactions.

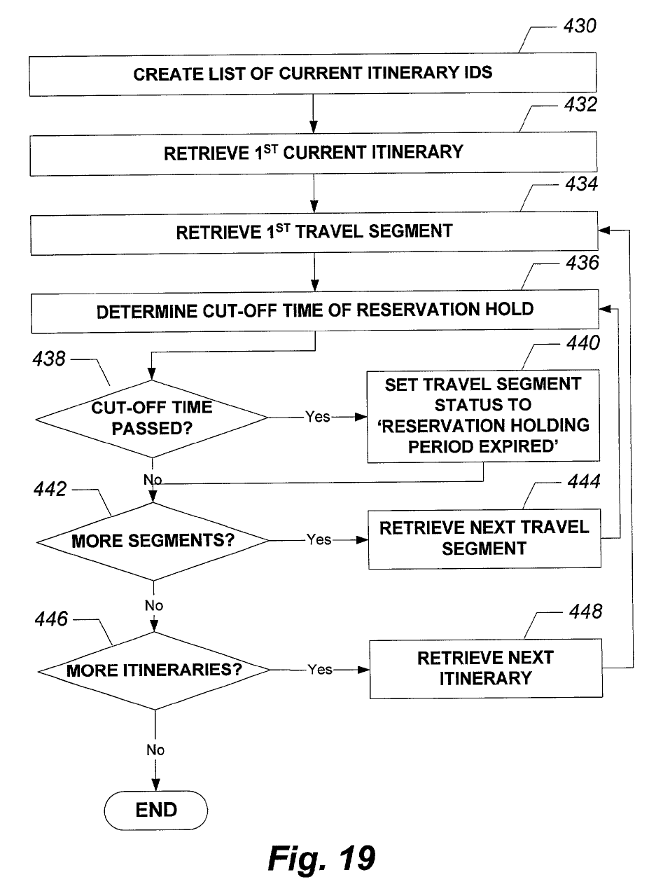

FIG. 19 shows a periodic batch process whereby the system checks for travel reservations that have been put on hold for too long without confirmation. The system begins by creating 430 a list of current itinerary IDs. Next, the system retrieves 432 the 1^{st} travel itinerary and the retrieves 434 the 1^{st} travel segment. Next, the system determines 436 the cut-off time of the reservation hold. If the travel segment is past its cut-off time 438, then the system sets 440 the travel segment's status to ‘Holding Period Expired’. Next, the system checks 442 to see if there are more segments. If there are more segments, then the system retrieves 444 the next travel segment and repeats the process with step 436. Otherwise, the system checks 446 to see if there are more itineraries. If there are more itineraries, then the system retrieves 448 the next itinerary and repeats the process with step 434. Otherwise, the process is completed.

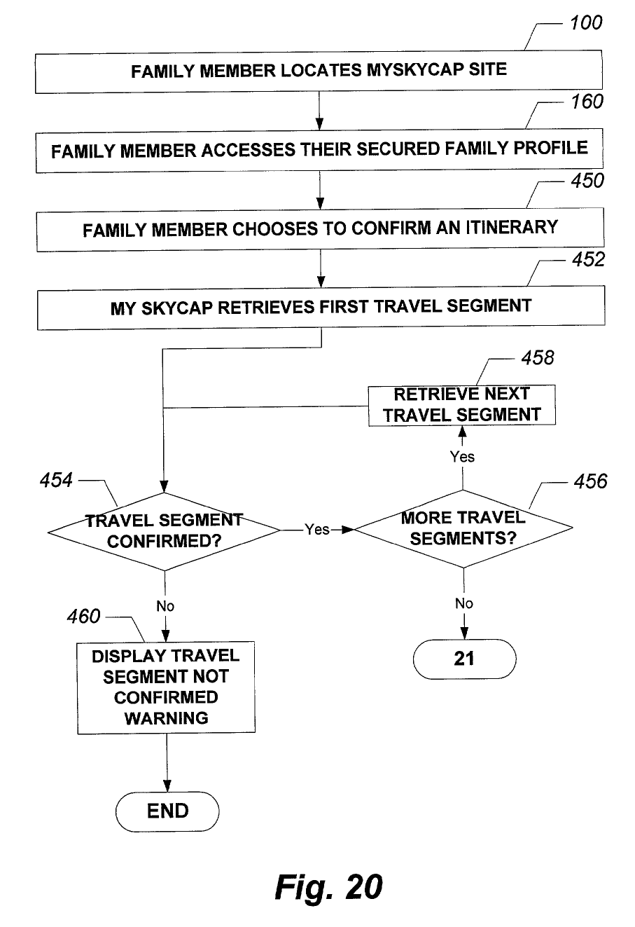

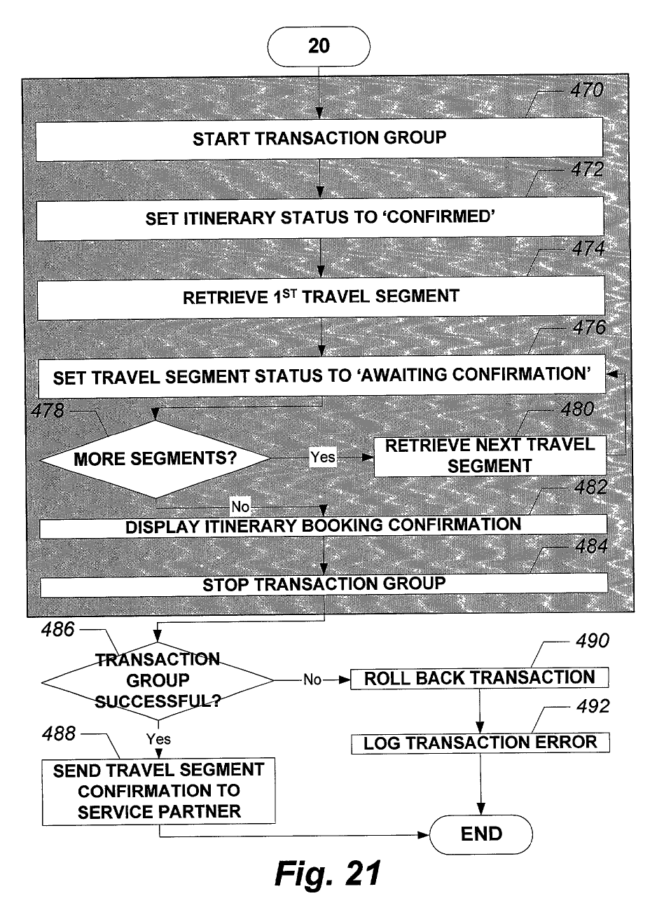

FIGS. 20 & 21 show the process whereby the profile owner would confirm an itinerary and submit all the travel segment reservations as a single transaction that either all succeeds or none succeeds. The process begins with FIG. 20 in which the family member locates 100 the site and then accesses 160 the secured family profile. Next, the family member chooses 450 to confirm their itinerary and the system retrieves 452 the first travel segment. The system then determines 454 if the travel segment as been confirmed. If the travel segment has not been confirmed, then the system displays 460 a travel segment not confirmed warning and ends the process. Otherwise, if the segment is confirmed, the system checks 456 for more travel segments. If there are more travel segments, then the system retrieves 458 the next travel segment and repeats the process with step 454. If all travel segments have been confirmed, then the process continues with FIG. 21. The shaded area of FIG. 21 shows all the transaction that must occur as a transaction group. If any single transaction fails, then the entire group is not performed. Note that this is commonly understood in the industry. The process begins with the system starting 470 a transaction group and then setting 472 the status of the itinerary to ‘Confirmed’. Next, the system retrieves 474 the 1^{st} travel segment and sets 476 its status to ‘Awaiting Confirmation’. Then, the system checks 478 for more segments. If there are more segments, then the next travel segment is retrieved 480 and the process repeats starting with step 476. Otherwise, if there are no more segments, then the system will display 482 an itinerary booking confirmation and stop 484 the transaction group. If it is determined 486 that the transaction group was successful, then the travel segment confirmation is sent 488 to the appropriate travel partner and ends. If the transaction group was not successful, then the entire transaction is rolled back 490 and a transaction error is logged 492.

Note that a call center can act as a proxy on the customer's behalf and make the reservation online.

6. mySkyCap Partner Architecture (FIG. 22-23)

FIGS. 22-23 show the architecture of mySkyCap partners. Travelers will interact with mySkyCap services at a mySkyCap facility or at a service partner facility. Travelers will be able to check their luggage at their hotel 500, car rental facility 502, parking facility 504, or mySkyCap facility 506. Partner and mySkyCap facilities will interact with the mySkyCap site 70 using either a mySkyCap remote unit 508 or a mySkyCap mobile unit 510. The mySkyCap remote unit 508 is an apparatus that allows the facility to accept luggage and perform all aspects of passenger check-in including issuing boarding passes, and bag tags. The mySkyCap mobile unit 510 is an apparatus that allows the facility to accept luggage that is tagged with a mySkyCap RF (Radio Frequency) tag and communicate to the mySkyCap site 70 via a mySkyCap Base Facility 512. Once the luggage is checked-in, it is transported 514 to the appropriate destination, whether that is an airport, bus/train station, cruise line, or home. Note that the most frequent destination would be an airport. FIG. 38, which is explained in section 8 mySkyCap Partner Transfer Processes.

FIG. 23 shows the components of the mySkyCap remote unit 508, the mySkyCap mobile unit 510, and the mySkyCap Base Facility 512. The mySkyCap remote unit 508 consists of a Radio Frequency Unit 522, a laptop/PC/Web Device 524, bar code reader 526, bag tag printer 528, and boarding pass printer 530. The remote unit 508 connects to the mySkyCap site 70 through the web device 524. The mySkyCap mobile unit 510 consists of a Radio Frequency Unit 522 which communicates with a Web Device 524 back at the base facility 512. The base facility 512 then connects to the mySkyCap site 70 through the web device 524.

### 7. Check-in Processes (FIGS. 24-29)

The pre-check-in process may occur in many different ways including directly on the web site or on a travel partner's site. This is shown in FIG. 24 by two alternative entry paths with optional tasks indicated by dashed lines depending upon which path is taken. Note other embodiments might be a phone call to customer service or access to the web site via a phone interface. The first path is by the travel passenger locating 100 the mySkyCap site and accessing 160 their secured family profile. Next, the travel passenger chooses 540 to check-in and then provides 542 their day of departure contact data such as cell phone, email, or pager number. The second path is by the travel passenger checking in 544 on a service partner site. If this path is taken, the service partner site 50 sends 546 a travel information change notice to the mySkyCap site 70. Next the system receives 548 the travel information change notice. Once the system has the required contact information, it is stored 550 in the Itinerary database 80. Next, the system determines 552 whether a boarding pass is needed and if so, it prints 554 boarding passes for all the members traveling in the family on the appropriate travel segment.

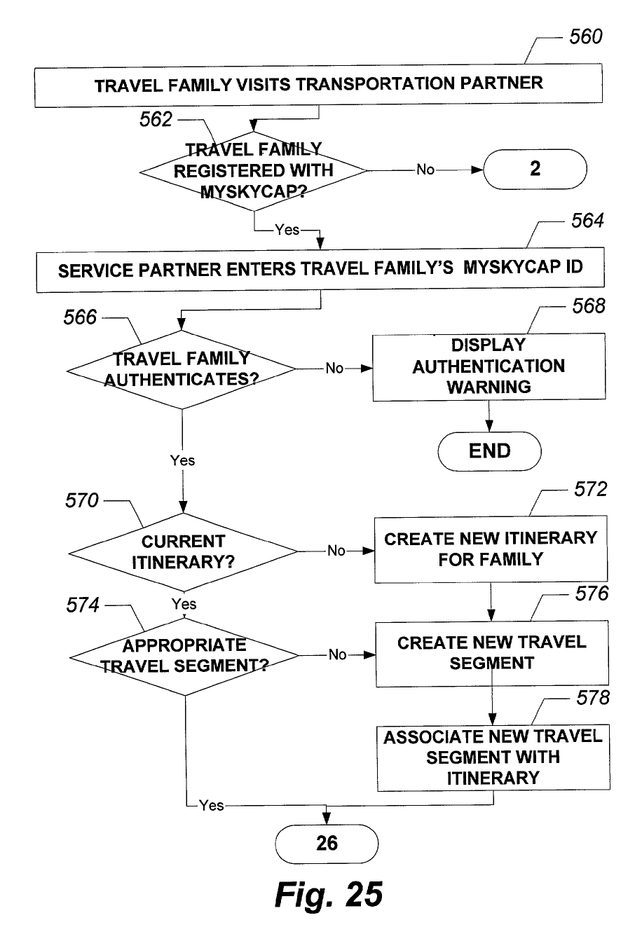

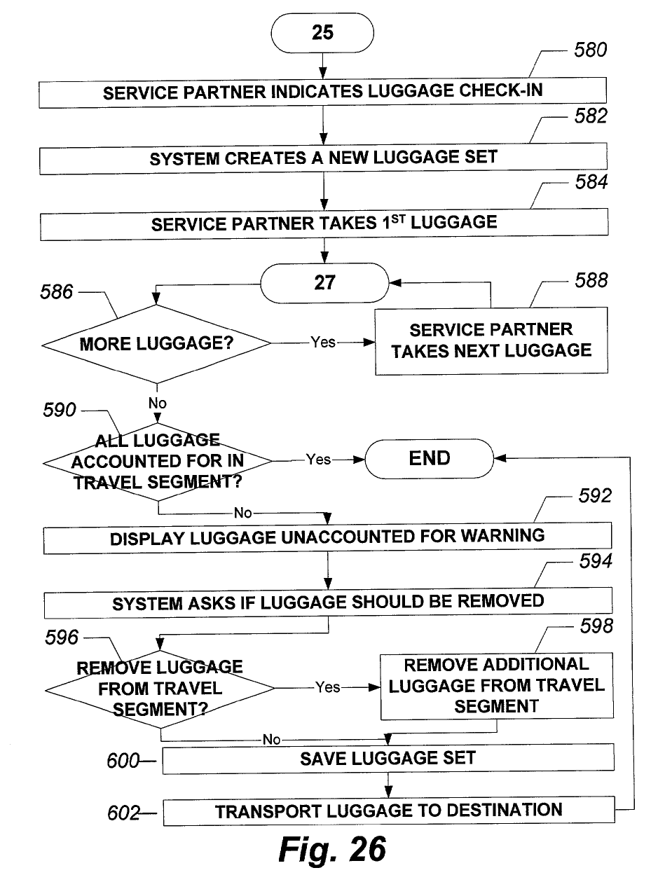

FIGS. 25 thru 29 show the process whereby luggage is checked with a service partner. Service partners may include hotels, car rental companies, parking facilities, shuttle van, bus/train companies, or mySkyCap facilities. The travel family first visits 560 a service partner site. At the service partner site, it is determined 562 if the travel family is currently registered with mySkyCap. If they are not registered, then they may use a kiosk to register their family with mySkyCap. This was described earlier in FIG. 2. Next, the service partner enters 564 the travel family's mySkyCap ID or scans it off an ID card and then attempts to authenticate 566 the family members. The authentication may be through photo IDs such as driver's license or with a special mySkyCap photo ID card that stores their mySkyCap ID along with other valuable information such as possible medications and travel emergency numbers. If the family is not authenticated by the system, then, the system will display 568 an authentication warning and the process ends. Another reason why the family may not be authenticated is if their profile is inactive due to non-payment or security checks. If the family is authenticated, then the system checks 570 and see if there is a current itinerary associate with the family's profile. If there is no current itinerary, then the system 572 creates a new itinerary for the family and then creates 576 a new travel segment. After creating the new travel segment, the system associates 578 the travel segment with the itinerary and continues the process with FIG. 26. If there already was a current itinerary, the system checks 574 to see if the luggage is associated with the appropriate travel segment. If not, the process continues with step 576 as described earlier. If it is already associated with the appropriate travel segment, then the process continues with FIG. 26.

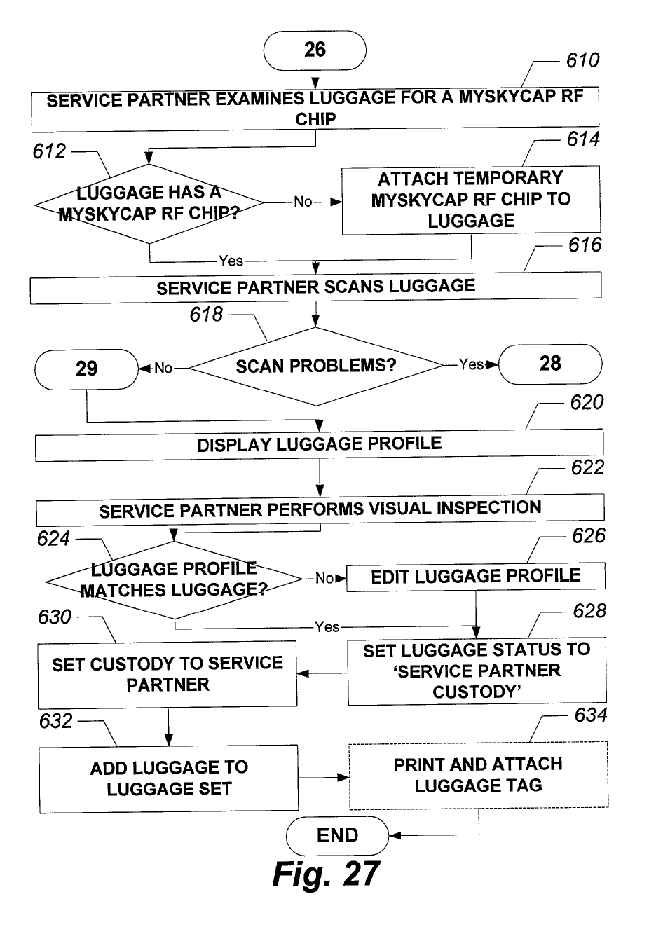

FIG. 26 begins with the service partner indicating 580 that they have luggage to check in to the system. Next, the system creates 582 a new luggage set. Next, the service partner takes 584 the first piece of luggage and performs the tasks in FIG. 27. FIG. 27 is performed with each piece of luggage. After the tasks of FIG. 27 have completed, the process continues in FIG. 26 with the system determining 586 if there is any more luggage to process. If there is more luggage, then the service partner takes 588 the next piece of luggage and performs the tasks of FIG. 27. When there is no more luggage to process, the system checks 590 and see if all the luggage that was associated with the current itinerary and travel segment has been processed. If the entire luggage has been processed, then the process is ended. If the entire luggage has not been processed, then the system displays 592 a ‘Luggage Unaccounted for’ warning. Next, the system asks 594 if the unaccounted for luggage should be removed from the current travel segment and itinerary. If the system determines 596 that the luggage should be removed, then the system removes 598 the addition unaccounted-for luggage from the travel segment. Next, the system saves 600 the luggage set and the service partner transports 602 the luggage to its destination.

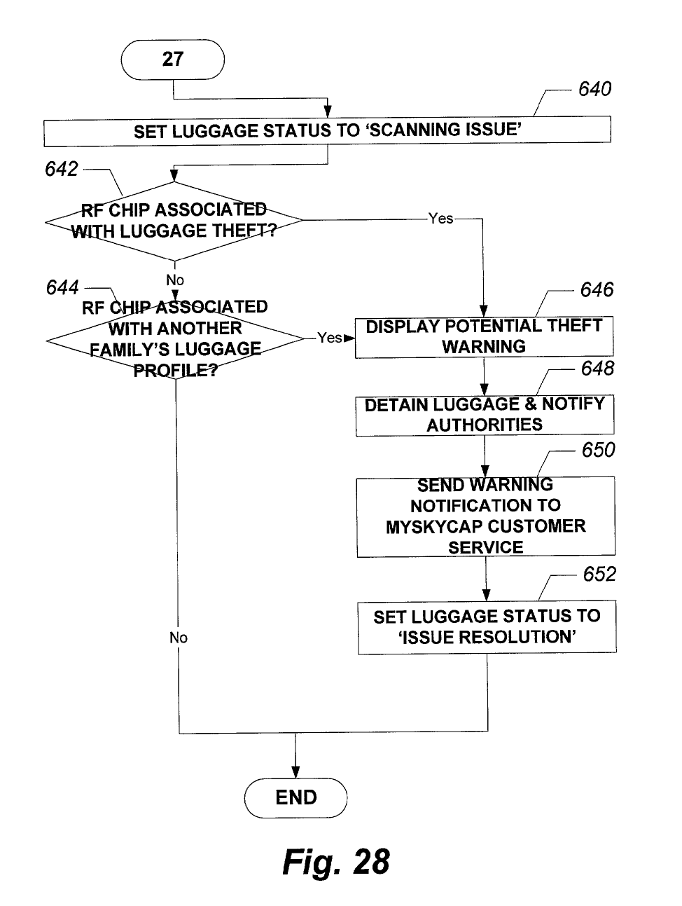

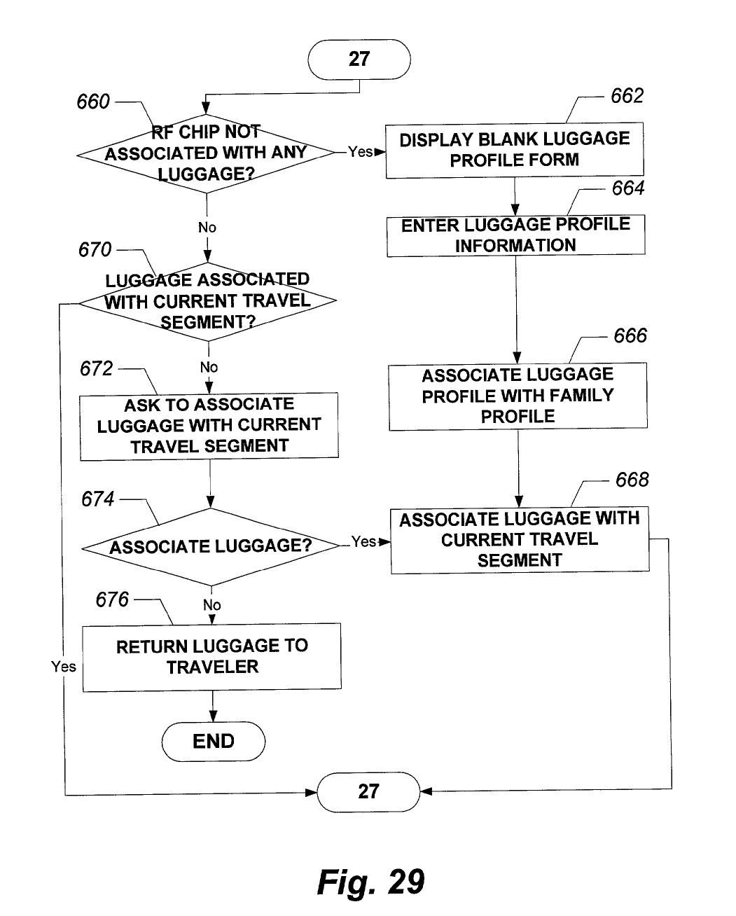

FIG. 27 shows the operations that are performed to process a single piece of luggage to check it in. First, the service partner examines 610 the luggage for a mySkyCap RF chip. If it is determined 612 that the luggage does not have an RF chip, then the service partner attaches 614 a temporary mySkyCap RF chip to the luggage. Once the luggage has an RF chip, the service partner scans 616 the luggage. If it is determined 618 that there are problems, then the process continues with FIG. 28. Otherwise, the process continues with FIG. 29. At the conclusion of the tasks in FIG. 29, the process continues with FIG. 27 by the system displaying 620 the luggage profile of the recently scanned luggage. Next, the service partner performs 662 a visual inspection and determines 624 if the luggage matches its online profile. If the luggage profile does not match the actual luggage, then the service partner edits 626 the luggage profile to make it consistent. For example, there may be new scratches and dents in the luggage not currently identified in the profile. Next, the system sets 628 the luggage status as ‘Service Partner Custody’ and sets 630 the custody to the service partner. Next, the luggage is added 632 to the luggage set. Finally, the system may optionally print 634 and attach a luggage tag. Note that a paper tag may not be necessary if the service partner such as an airline recognizes the mySkyCap RF unit. If necessary, the system may access the partner database 82 to determine business rules to print the luggage tags.

FIG. 28 shows the operations of handling scanning errors. The system begins by setting 640 the luggage status as ‘Scanning Issue’. If the system determines 642 that the mySkyCap RF chip is associated with luggage theft or the system determines 644 that the RF chip is associated with another family's luggage profile, then the system begins by displaying 646 a ‘Potential Theft’ warning. Next, the service partner detains 648 the luggage and notifies the authorities. Next, the system sends 650 a warning notification to mySkyCap Customer Service and then sets 652 the luggage status to ‘Issue Resolution’.

FIG. 29 is a continuation of FIG. 27 and begins with the system determining 660 if the RF chip is not associated with any luggage. If the RF chip is not associated with any luggage, then the system displays 662 a blank luggage profile from which they enter 664 the appropriate profile information. Next, the system associates 666 the luggage profile with the family profile and associates 668 the luggage with the current travel segment. If the RF chip is associated with the luggage, then the system determines 670 if the luggage is associated with the current travel segment. If the luggage is associated with the current travel segment, then the process continues by returning to FIG. 27. Otherwise, the system asks 672 if luggage should be associated with the current travel segment. If it is determined 674 that the luggage should be associated with the current travel segment, then the system associates 668 the luggage with the current travel segment and continues by returning to FIG. 27. Otherwise, if the luggage should not be associated with the current travel segment, then the luggage is returned 676 to the traveler.

8. mySkyCap Partner Transfer Processes (FIGS. 30-32)

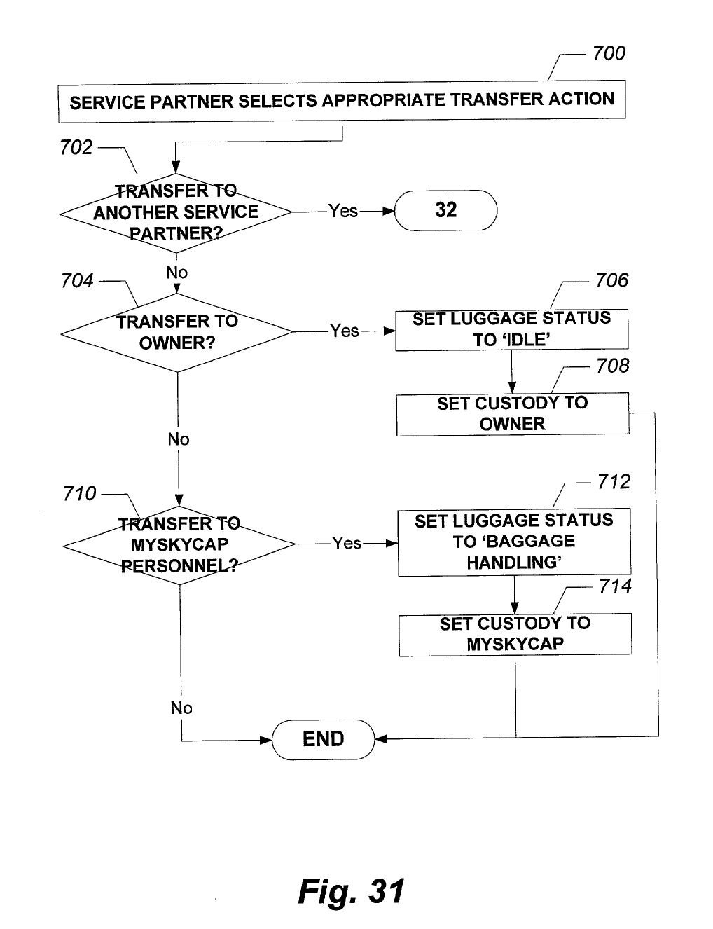

FIGS. 30-32 show the process whereby one partner transfers the luggage set to another partner and thus the next travel segment of a family's itinerary. FIG. 30 starts with a service partner choosing 680 to make a transfer. Next, the system displays 682 a list of luggage sets currently in custody of the service partner. Then, the service partner selects 684 the 1^{st} luggage set and continues the process with FIG. 31, which processes a single piece of luggage. Upon returning from FIG. 31, the system determines 686 if there is more luggage to process. If there is more luggage, then the service partner selects 688 the next luggage set and repeats with FIG. 31. Note, an example of this being used is a shuttle van delivering different families to different airline curb check-in locations. Once all the luggage sets have been processed, the system selects 690 the 1^{st} traveler associated with luggage set and then sets 692 the traveler's status to ‘Idle’. If it is determined 694 that there are more travelers, then the system selects 696 the next traveler associated with luggage set and repeats the process with step 692.

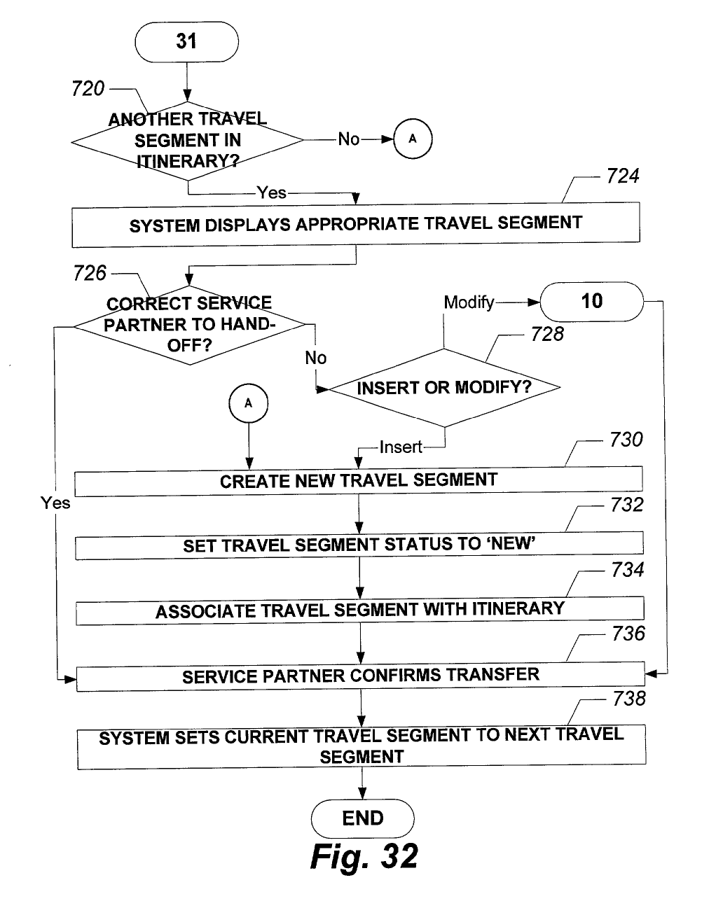

With regards to FIG. 31, a service partner selects 700 an appropriate transfer action with the system. If it is determined 702 that the transfer is to be to another service partner, then the process continues with FIG. 32. Otherwise, if it is determined 704 the transfer is to the owner, then the system sets 706 the luggage status to ‘Idle’ and sets 708 the custody to the owner. Otherwise, if it is determined 710 the transfer is to mySkyCap Personnel, such as baggage handling at an airport, then the system sets 712 the luggage status to ‘Baggage Handling’ and sets 714 the custody to mySkyCap.

FIG. 32 shows the process whereby one service partner hands off the process to another service partner. The process begins by determine 720 if there is another travel segment of the current itinerary associated with the luggage set. If not, then the process continues with step 730 as described below. If there is another travel segment, then the system displays 724 the next travel segment and the service partner determines 726 if the correct service partner is listed for the hand-off. If yes, then the process continues with step 736 as described below. If the new service partner is not associated with new travel segment, then the old service partner determines 728 whether to modify the current travel segment or insert a new one. If the choice is to modify the travel segment, then the process continues with FIG. 10 and upon returning from FIG. 10 continues with step 736 as described below. If the choice is to insert a new travel segment, then the system creates 730 a new travel segment and sets 732 its status to ‘New’. The new travel segment is then associated 734 with the appropriate itinerary. Next, the old service partner confirms 736 the transfer and then the system sets 738 the current travel segment to the next segment of the itinerary.

9. mySkyCap Administration Handling Processes (FIGS. 33-37)

FIG. 33 shows the process of mySkyCap Customer Service handling a potential theft. It begins by mySkyCap Customer Service receiving 740 a warning message from a service partner. Next, the mySkyCap Customer Service Representative chooses 742 to resolve the issue and the system displays 744 the luggage profile of both the current luggage profile currently associated with the RF chip and the luggage profile being checked in with the RF chip. The mySkyCap Customer Service Representative resolves 746 which profile is correct. They may do this be calling the family currently associated with the RF chip. If it is determined 748 that the registered profile is the correct one, then the system sends 750 a Potential Theft notice to the service partner. Otherwise, if the new profile is the correct one, then the system sends 752 a Luggage Resolution notice to the service partner. The process ends with the system setting 754 the luggage status to ‘Idle’. The service partner would then attempt to re-scan the luggage if it was not theft.

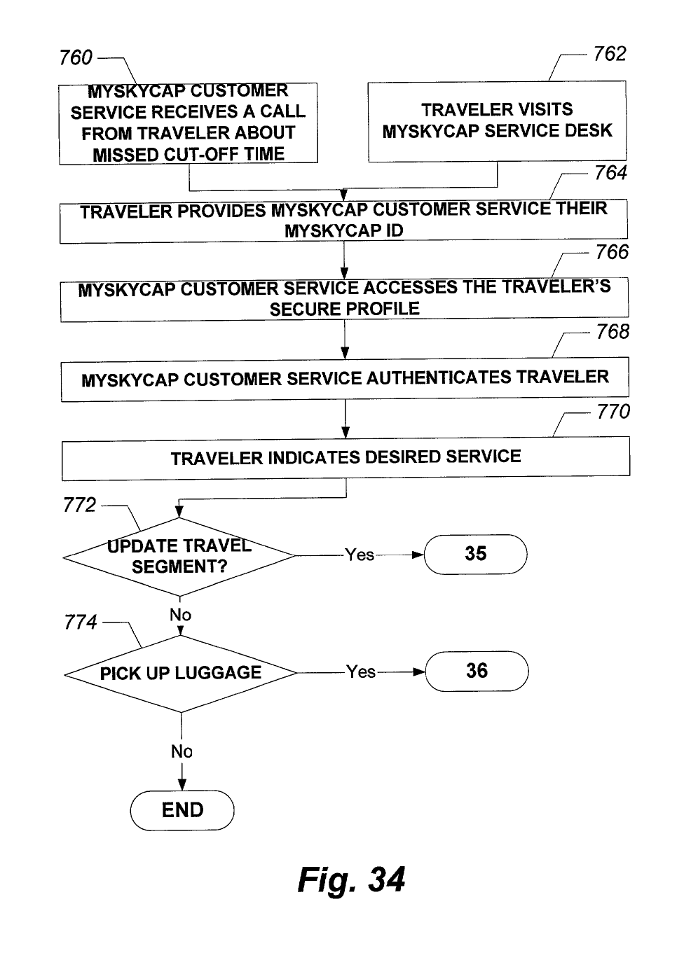

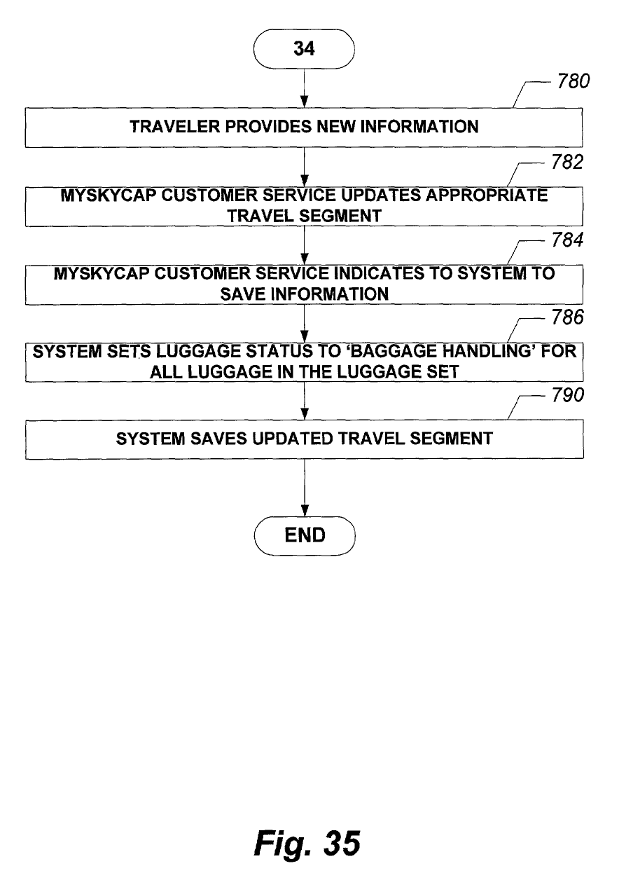

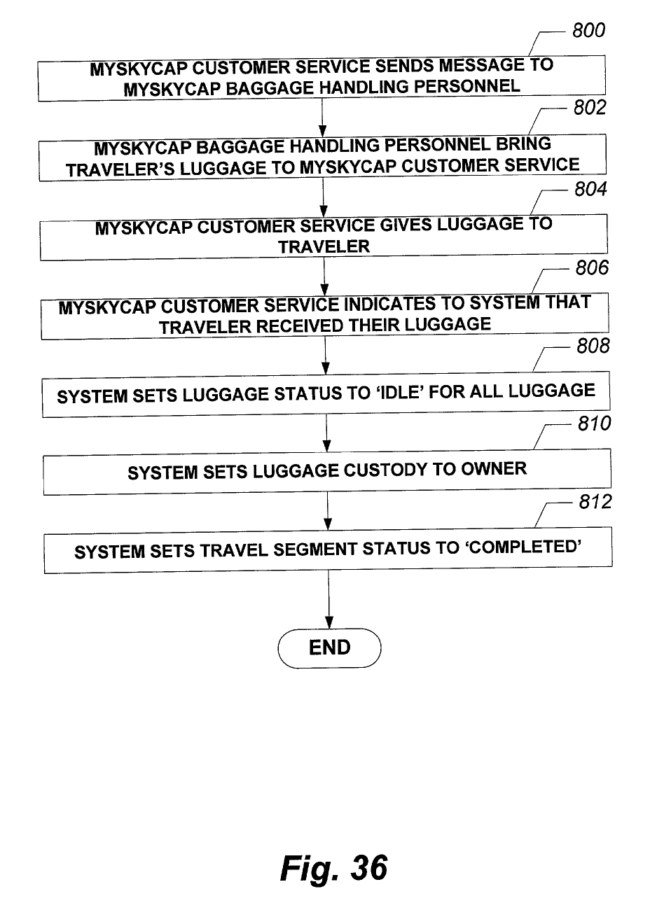

FIG. 34 shows the process of mySkyCap Customer Service resolving a ‘Missed Cut-off Time’ luggage status. It begins with two alternate paths. Either the mySkyCap Customer Service Representative receives 760 a phone call from a traveler or the traveler visits 762 a mySkyCap Service Desk. Either way the traveler provides 764 their mySkyCap ID from which the customer service representative accesses 766 the traveler's secured profile and then authenticates 768 them. Possible ways of authenticating them might be a photo ID if in person or a secret word or phrase if on the telephone. The traveler then indicates 770 their desired service and it is determined 772 if they want to modify a travel segment. If they do, then the process continues with FIG. 35. Otherwise, if it is determined 774 that they want to pick up luggage, then the process continues with FIG. 36. Otherwise, the process is complete.

FIG. 35 continues from FIG. 34 with the traveler proving 780 new information to update the travel segment and then the customer service representative updating 782 the appropriate travel segment. Next, the customer service representative indicates 784 to the system to save the information. The system then sets 786 the luggage status to ‘Baggage Handling’ for all luggage in the luggage set and completes the process by saving 790 the updated travel segment.

FIG. 36 also continues from FIG. 34 with the customer service representative sending 800 a message to the mySkyCap Baggage Handling personnel. Upon receiving this message, the mySkyCap Baggage Handling personnel bring 802 the luggage to the mySkyCap Customer Service desk. Next, the customer service representative gives 804 the luggage to the traveler and indicates 806 to the system that the traveler has received their luggage. The system then sets 808 the luggage status to ‘Idle’ for all the luggage in the luggage set and sets the luggage custody to owner. The process ends by the system setting 812 the travel segment status to ‘Completed’.

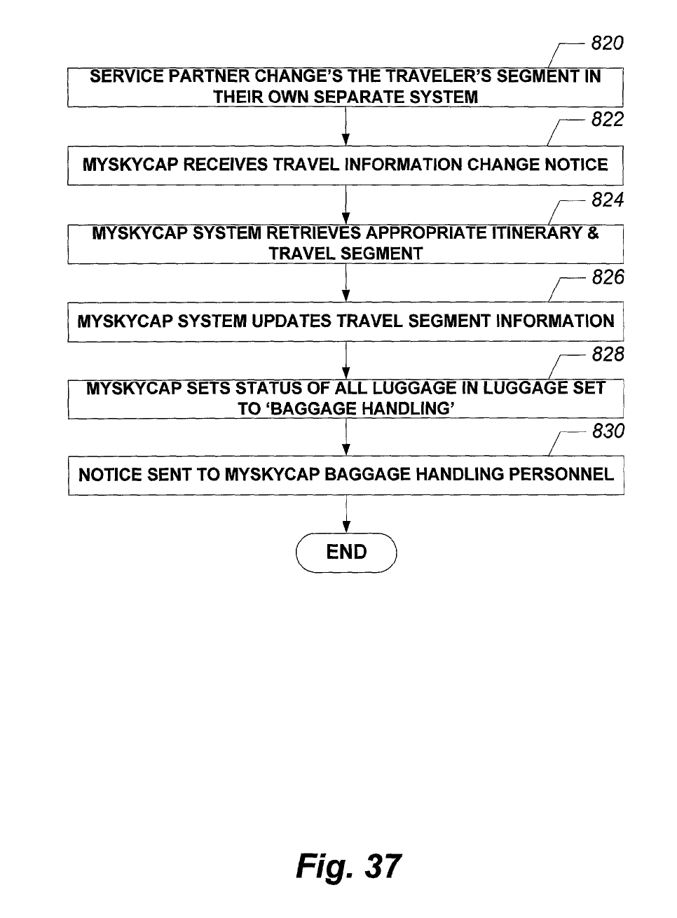

FIG. 37 shows an alternative process of a travel segment being automatically updated from information received from a partner's separate system. For example, a traveler may change the flight information of a given travel segment for a later flight due to a canceled flight and the airline system would automatically send this information to the mySkyCap system. It begins by a service partner changing 820 a traveler's segment in their own separate system. The service partner's system 52 sends 822 a notification of change to mySkyCap Server application 72. The preferred embodiment of this communication is XML. The mySkyCap system retrieves 824 the appropriate itinerary and travel segment and then updates 826 the appropriate travel segment information. Next, the mySkyCap system sets 828 the status of all the luggage in the luggage set to ‘Baggage Handling’. Lastly, a notice is sent 830 to mySkyCap Baggage Handling Personnel so that they can deal with the luggage.

10. mySkyCap Airport Handling Processes (FIGS. 38-42)

FIG. 38 shows the mySkyCap facilities at the airport and how it interacts with airline facilities. Note that this architecture may be used at non-airline service partners also such as train and bus stations. Luggage is transported to the mySkyCap facility either at the airport or some other transportation facility for handling. Luggage is received and scanned at the mySkyCap Common Use Sortation and Security System 840. The mySkyCap Common Use Sortation and Security System 840 is composed of four main areas mySkyCap RF Baggage Handling 842, mySkyCap RF Bag Tag System 844, CTX X-Ray Device 846, and the mySkyCap RF Sortation System 848. Luggage is first dropped off at the mySkyCap RF Baggage Handling 842 and precedes to the mySkyCap RF Sortation system 848 via the CTX X-Ray Device 846. If an airline baggage tag is required and not found on the luggage, then it travels to the mySkyCap RF Bag Tag System 844 to have the appropriate airline baggage tag applied and then sent through the CTX X-Ray Device 846 to the mySkyCap RF Sortation system 848 area. Any luggage that fails the security check of the CTX X-Ray Device 846 is delivered to the Baggage Reject area for manual processing, where it is delivered to the appropriate airline's resolution bay 854. Luggage that passes the security check is delivered to the appropriate airline 852. The airline in turn will deliver it to the appropriate flight luggage area 856.

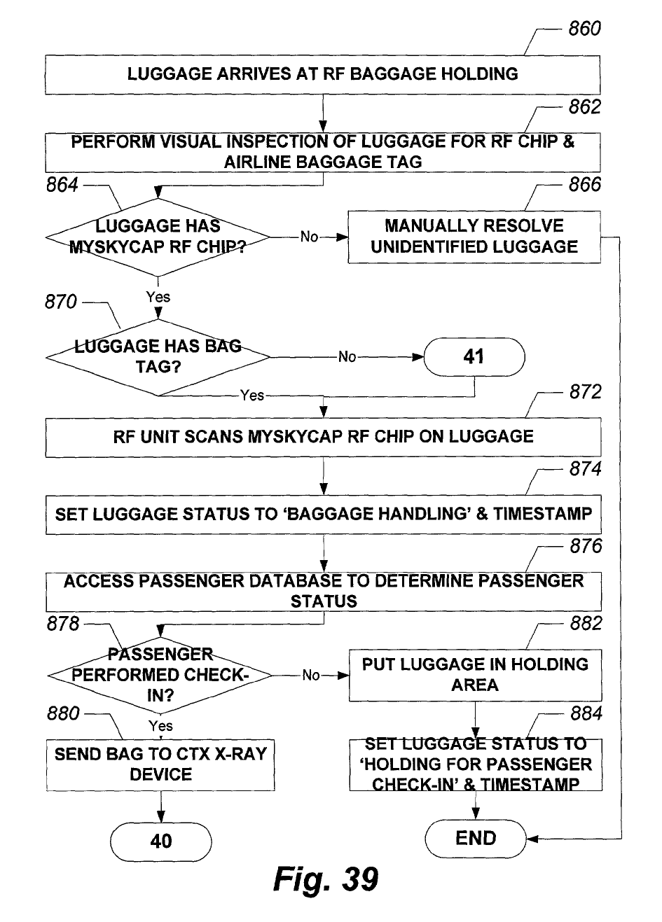

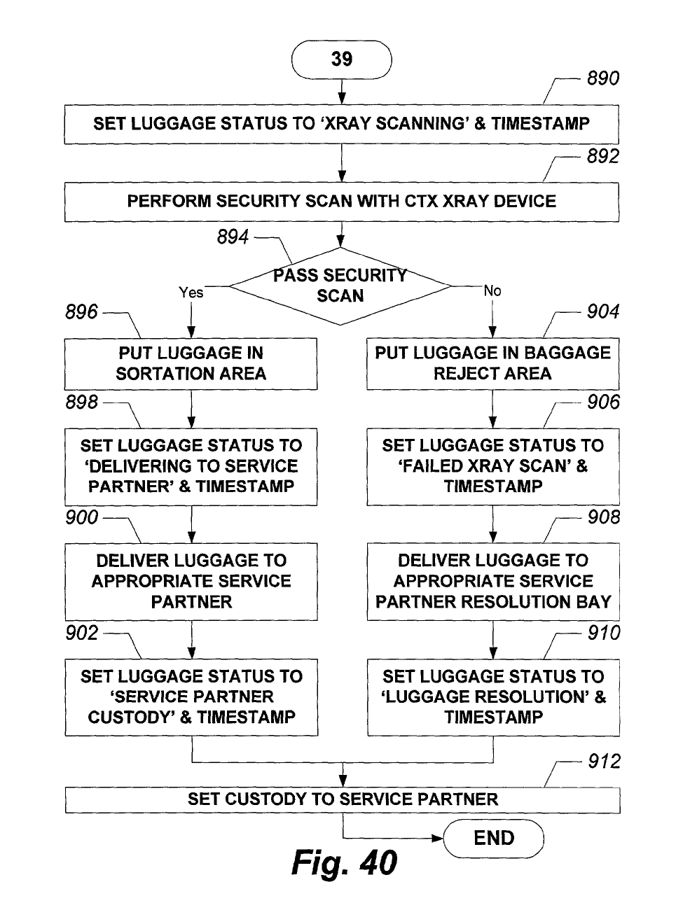

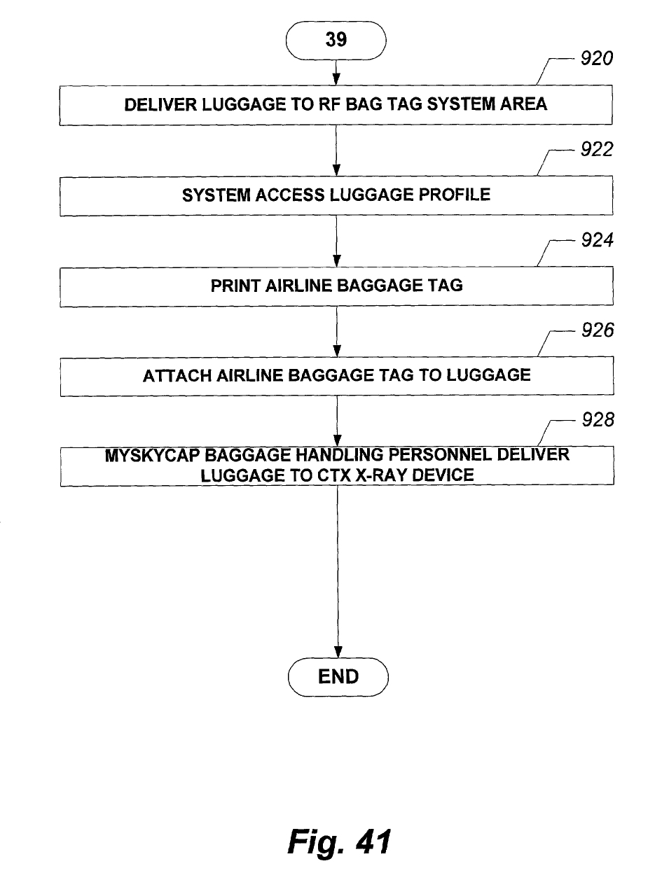

FIG. 39 shows the baggage handling processes for security and delivery to the appropriate airline. Luggage is first dropped 860 off at the mySkyCap RF Baggage Handling 842 area where it is scanned with the RF Unit 522. A visual inspection is performed 862 to check for RF chip and baggage tag. If it is determined 864 that there is no mySkyCap RF chip, then the luggage is removed and manually resolved 866. Otherwise, if it is determined 870 that the luggage requires an airline bag tag and one is not on the luggage, then the process continues with FIG. 41. Otherwise, the RF Unit 522 is used to scan 872 the luggage and then the system sets 874 the luggage status to ‘Baggage Handling’ and timestamps the entry. Next, the system accesses 876 the traveler database 74 to determine the passenger's status. If it is determined 878 that the passenger has not checked-in yet, then the luggage is put 882 in the holding area and the system sets 884 the luggage status to ‘Holding for Passenger Check-in’ and timestamps the entry. Otherwise, if the passenger has already checked-in, then the bag is sent 880 to the CTX X-Ray Device 846 and the process continues with FIG. 40.

FIG. 40 is a continuation of the baggage handling process once the luggage is delivered to the CTX X-Ray Device 846. It begins by the system setting 890 the luggage status to ‘X-Ray Scanning’ and timestamps the entry. Next, a security scan is performed 892 by the CTX X-Ray Device 846. If the luggage passes the security scan then it is put 896 in the MySkyCap RF Sortation System area 848 and sets 898 the luggage status to ‘Delivering to Airline’ and timestamps the entry. Next, the luggage is delivered 900 to the appropriate airline 852. Once the airline receives the luggage, the system sets 902 the luggage status to ‘Airline Custody’ and timestamps the entry. If the luggage doesn't pass the security scan then it is put 904 in the Baggage Reject area 850. Next the system sets 906 the luggage status to ‘Security X-Ray Scan Failed’ and the entry is time stamped. Then, the luggage is delivered 908 to the appropriate airline resolution bay 854 and the luggage status is set 910 to ‘Airline Resolution’ and the entry is time stamped. The process completes by the system setting 912 the custody of the luggage to the service partner.

FIG. 41 shows the steps taken if the luggage is determined to not have an airline baggage tag and that airline requires one. The process begins by the luggage being delivered 920 to the Bag Tag System area 844. Next, the system accesses 922 the luggage profile and then prints 924 an airline baggage tag. The mySkyCap Baggage Handling personnel take this tag and attach 926 it to the luggage and then deliver 928 it to the CTX X-Ray Device 846, which completes the process.

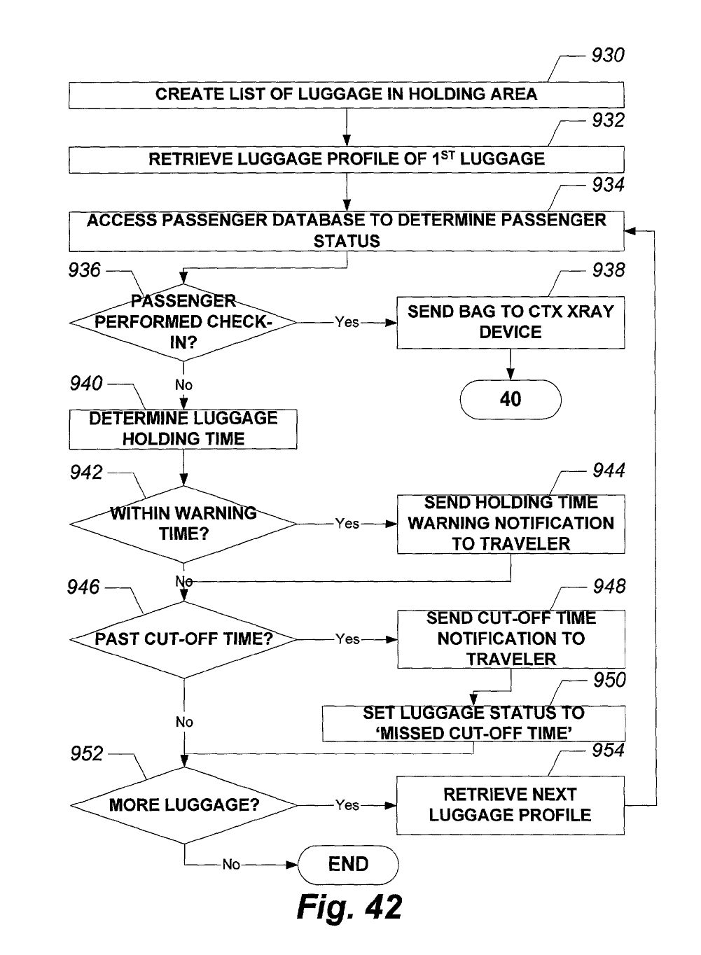

FIG. 42 shows a process that is run periodically to process luggage that is in the holding area. It begins by creating 930 a list of luggage in the holding area and then retrieves 932 the luggage profile of the first piece of luggage. From the luggage profile, the system accesses 934 the traveler database 74 to determine the associated passenger's status. If it is determined 936 that the passenger has already checked in with the airline then the system sends 938 the bag to the CTX X-Ray device 846 and continue the process with FIG. 40. Otherwise, the system determines 940 the luggage holding time. If the holding time is determined 942 to be within the warning time, then a warning notification is sent 944 to the traveler. This notification may be a call to a cell phone with an automated voice or a message sent to a pager, whichever method the traveler chose when they checked-in with the mySkyCap site. Other embodiments may be used in the future and this description does not limit the implementations. If it is determined 946 that the luggage has past its cut-off time for loading onto an airline because the passenger has not checked-in with the airline, then the system sends 948 a ‘Cut-off Time’ notification to the traveler as described earlier and sets 950 the luggage status to ‘Missed Cut-off Time’. Next, the system determines 952 if there is more luggage to check and if there is, then the next luggage profile is retrieved 954 and the process repeats starting with step 934. Otherwise, the process ends.

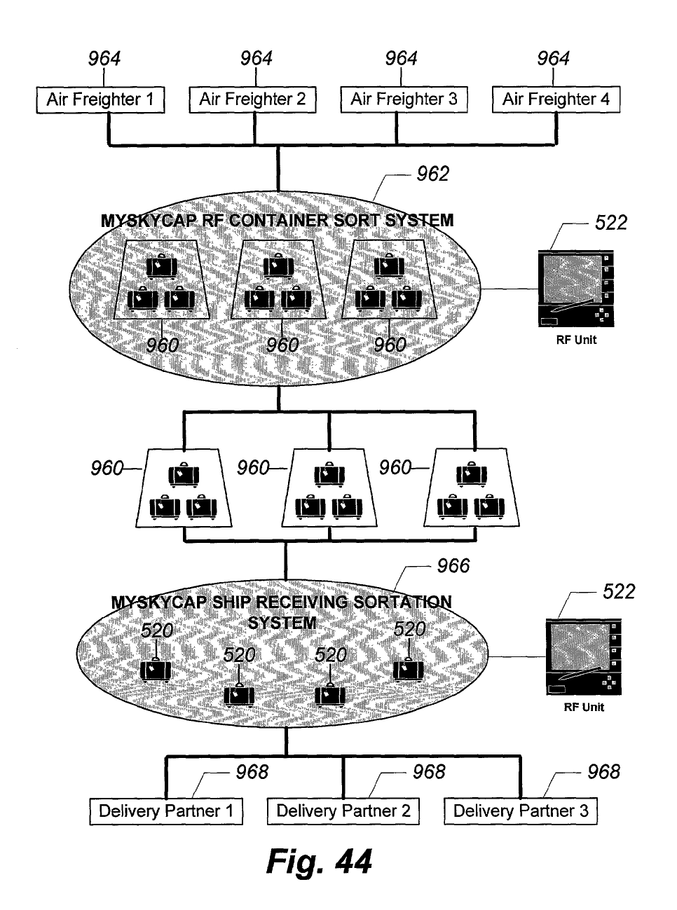

11. mySkyCap Air Freighter Processes (FIGS. 43-44)

FIG. 43 shows an alternative embodiment whereby the luggage travels via an Air Freighter rather than on the same airline as the passenger. The mySkyCap Common Use Sortation and Security System 840 is described in detail in FIG. 38. In this option, luggage goes through the same security procedures but rather than traveling on the same airplane as the passenger, it travels by air freight. Thus, for any luggage that is traveling by air freight, it is sorted and put into luggage containers 960, which are then routed to the mySkyCap RF Container Sort system 962. This system has a RF Unit 522 which is used for tracking the containers. At this point, the luggage containers 960 are loaded onto the appropriate Air Freighter 964 and delivered to the appropriate location.

FIG. 24 shows the process of the mySkyCap Air Freighter upon reaching its destination. Upon reaching the destination, the luggage containers 960 are off-loaded and put into the mySkyCap RF Container Sort system 962 described previously. From here, the luggage containers 960 are either loaded onto another Air Freighter 964 or routed to a location to be unpacked. If the luggage 520 is to be unpacked, it is placed in the mySkyCap Ship Receiving Sortation System 966 and from their delivered to the appropriate Delivery Partner 968.

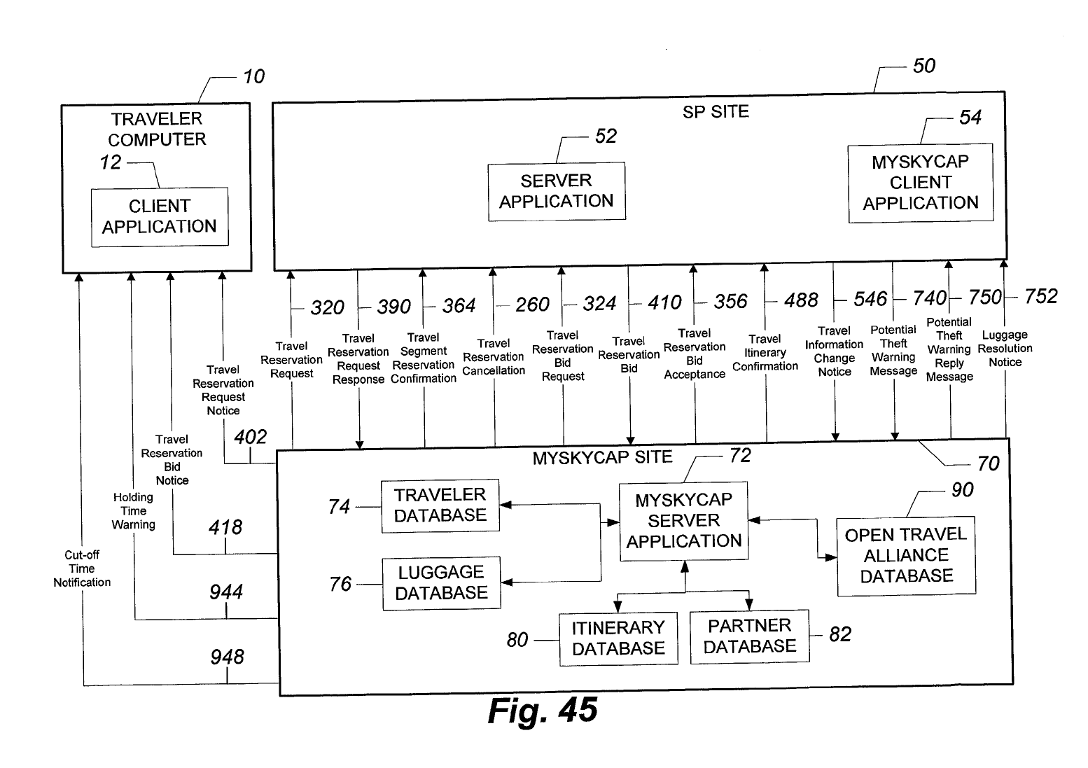

### 12. Communication Processes (FIG. 45)

FIG. 45 shows the communication process occurring between the mySkyCap site 70, the SP site 50, and the traveler 10. If a traveler selects a fixed bid, then a Travel Reservation Request 320 is sent to the service partner site 50. Later, the service partner sends back a Travel Reservation Request Response 390 and upon receiving it, the system sends a Travel Reservation Request Notice 402 to the traveler 10. If a traveler confirms a reservation after receiving a reservation acceptance, then a Travel Segment Reservation Confirmation 364 is sent to the service partner site 50. If the traveler chooses to cancel a travel segment then a Travel Reservation Cancellation 260 is sent to the service partner site 50. Otherwise, if the traveler selects to have multiple service partners bid on the travel segment, then a Travel Reservation Bid Request 324 is sent to all the selected service partner sites 50. These service partners in turn, send back a Travel Reservation Bid 410, which results in the system sending a Travel Reservation Bid Notice 418 to the service partner site 50. If a traveler accepts one of the bids, then a Travel Reservation Bid Acceptance 356 is sent to the service partner site 50. Once all the travel segments have been confirmed, the traveler then chooses to confirm the entire itinerary at which point the system sends a Travel Itinerary Confirmation 488 to all the service partner sites 50 on the itinerary. Note, that the system does not actually book any reservations until the entire itinerary is completed and thus guarantees that the traveler will only be charged if the entire itinerary is completed.

If the details of a travel segment change with a service partner for some reason, such as a canceled flight, a service partner may make the change in their own proprietary system and then sends a Travel Information Change Notice 546 to the mySkyCap site 70.

Upon checking in with a service partner, if the system detects a potential theft from scanning the Radio RF chip in the luggage, then the service partner site 50 sends a Potential Theft Warning Message 740 to the mySkyCap Site 70. Once the mySkyCap Customer Service resolves the situation, they send either a Potential Theft Warning Reply Message 750 or a Luggage Resolution Notice 752.

After a traveler has checked in their luggage, it is held in a holding area until they check-in for their travel segment (e.g. flight) with the appropriate service partner (e.g. airline). If the luggage remains in holding after a given amount of time, the traveler will be sent a Holding Time Warning 944. If they continue to not check-in and it passes the cut-off time of when the luggage can still be loaded onto the appropriate travel segment (e.g. flight), then a Cut-off Time Notification 948 is sent to the traveler.

### CONCLUSION, RAMIFICATIONS AND SCOPE

Thus the reader will see that the mySkyCap site defined in this invention provides a highly efficient and convenient method of providing for passenger and luggage handling services. Furthermore, this invention has the additional advantages in that
It permits the travelers and service providers to interact in a secure environment.
It permits convenient travel planning and efficient use of time.
It permits the scheduling and negotiation of individual travel segments separately by only liable once an entire itinerary is confirmed.
It reduces the possibility of credit card fraud.

Although the description above contains much specificity, this should not be construed as limiting the scope of the invention, but as merely providing illustrations of some of the presently preferred embodiments of this invention. Many variations are possible. For example, the graphical look and feel and screen layout will periodically change to provide fresh content.

Thus the scope of the invention should be determined by the appended claims and their legal equivalents, rather than by the examples given.

We claim:

1. A system for providing pickup and delivery of luggage over a distributed network, the system comprising:
a. a luggage transport service running a luggage transport service site operably connected to at least one computer server connected to the distributed network, the server running a luggage transport server application;
b. a plurality of luggage carriers each having one or more sites, for each luggage carrier, a site operatively associated with at least one computer connected to the distributed network running at least one server application to provide online service to users over the distributed network, and for each luggage carrier, a site operatively associated with at least one computer connected to the distributed network running at least one luggage transport client application operatively configured to interact over the distributed network with the luggage transport server application;
c. a plurality of user input/output devices operatively configured to access an online service over the distributed network;
d. the luggage transport server application operatively connected to data storage residing on computer readable media, and the luggage transport server application configured to:
i. receive and store luggage travel segment data from a user;
ii. programmatically match a luggage travel segment to a selected luggage carrier;
iii. output selected luggage travel segment data to the selected luggage carrier.

2. The system of claim 1 wherein the luggage transport server application is further configured to:
iv. receive and store luggage travel segment data from the selected luggage carrier;
v. output luggage travel segment data to the user.

3. The apparatus of claim 1 wherein the luggage transport server application is further configured to:
iv. receive and store luggage travel segment bid data from the selected luggage carriers;
v. output luggage travel segment bid data to the user;
vi. receive and store luggage travel segment bid acceptance data from the user;
vii. output luggage travel segment bid acceptance data to the selected luggage carriers.

4. A system for providing user selectable luggage carrier pickup and delivery of luggage from among multiple service providers over a distributed network, the system comprising:
a. a luggage transport service running at least one computer server connected to the distributed network, the server running a luggage transport server application;
b. a plurality of luggage carriers each having one or more sites, for each luggage carrier, a site operatively associated with at least one computer connected to the distributed network running at least one server application to provide online service to users over the distributed network, and for each luggage carrier, a site operatively associated with at least one computer connected to the distributed network running at least one luggage transport client application operatively configured to interact over the distributed network with the luggage transport server application;
c. a plurality of user input/output devices operatively configured to access an online service over the distributed network;
d. the luggage transport server application operatively connected to data storage residing on computer readable media, and the luggage transport server application configured to:
i. receive and store luggage travel segment data from a user;
ii. programmatically match a luggage travel segment to a selected luggage carrier;
iii. output selected luggage travel segment data to the selected luggage carrier;
iv. receive and store luggage travel segment data from the selected luggage carrier;
v. output luggage travel segment data to the user.

5. The system of claim 4 wherein the luggage transport server application is further configured to:
i. programmatically match a luggage travel segment to a plurality of selected luggage carriers;
ii. output selected luggage travel segment data to the plurality of selected luggage carriers;
iii. receive and store luggage travel segment bid data from each luggage carrier;
iv. output luggage travel segment bid data to the user;
vi. receive and store luggage travel segment's bid acceptance data from the user;
vii. output luggage travel segment's bid acceptance data to the plurality of luggage carriers.

6. The system of claim 4 wherein the luggage transport server application is further configured to:
i. receive and store a plurality of luggage travel segments' data from a user;
ii. programmatically match each luggage travel segment to at least one selected luggage carrier;
iii. output selected luggage travel segment data to each selected luggage carrier;
iv. receive and store luggage travel segment data for each segment from the matched luggage carriers;
v. output selected luggage travel data for each segment to the user.

7. The system of claim 4 wherein the luggage transport server application is further configured to:
i. receive and store a plurality of luggage travel segments' data from a user;
ii. programmatically match each luggage travel segment to a plurality of selected luggage carriers;
iii. output selected luggage travel segment data from each segment to each selected luggage carrier;
iv. receive and store each luggage travel segments' bid data from a plurality of luggage carriers;
v. output luggage travel segments' bid data to the user;
vi. receive and store luggage travel segments' bid acceptance data from the user;
vii. output luggage travel segments' bid acceptance data to the plurality of luggage carriers.

8. The system of claim 1, further comprising step e.i. as follows:
e. the luggage transport server application operatively connected to data storage residing on computer readable media, and the luggage transport server application configured to:
i. receive and store family member profile input and modification data from the user.

9. The system of claim 8, further comprising step e. ii. as follows:
e. the luggage transport server application operatively connected to data storage residing on computer readable media, and the luggage transport server application configured to:
ii. receive and store luggage profile input and modification data from the user within the user's family member profile.

10. A method for providing user selectable luggage carrier pickup and delivery of luggage over a distributed network, the method comprising the steps:
a. a luggage transport service running a luggage transport server application on at least one computer server connected to the distributed network;
b. a plurality of luggage carriers each running at least one online service server application on at least one computer server to provide access to luggage services over the distributed network to a plurality of users;
c. the plurality of luggage carriers also each running at least one luggage transport client application on at least one computer, the client application interoperably connected for data exchange with the luggage transport server application over the distributed network;
d. the luggage transport server application receiving and storing in a storage medium travel segment data related to a luggage travel segment from at least one of the plurality of users;
e. the luggage transport service computer programmatically matching the travel segment data to luggage transport data from one or more selected luggage carriers to create output match data;
f. the luggage transport service computer outputing the output match data for the matching luggage travel segment to the selected luggage carriers.

11. The method of claim 10 further comprising the steps:
g. the luggage transport server receiving and storing travel segment bid data related to the luggage travel segment from the selected luggage carriers;
h. the luggage transport server outputing the bid data for the luggage travel segment to the user;
i. the luggage transport server receiving and storing bid acceptance data for a selected luggage carrier from the user;
j. the luggage transport server outputing bid acceptance data to the selected luggage carrier.
